(19) United States
(12) Patent Application Publication
(10) Pub. No.: US 2022/0091487 A1
(43) Pub. Date: Mar. 24, 2022

(54) SHOOTING CONTROL METHOD AND SHOOTING CONTROL DEVICE

(71) Applicant: SZ DJI TECHNOLOGY CO., LTD., Shenzhen (CN)

(72) Inventor: Zhuo XIE, Shenzhen (CN)

(73) Assignee: SZ DJI TECHNOLOGY CO., LTD., Shenzhen (CN)

(21) Appl. No.: 17/185,973

(22) Filed: Feb. 26, 2021

Related U.S. Application Data
(63) Continuation of application No. PCT/CN2020/116854, filed on Sep. 22, 2020.

(51) Int. Cl. G03B 17/56; G03B 13/36; H04N 5/232

(52) U.S. Cl. CPC G03B 17/563; G03B 17/561; H04N 5/232127; H04N 5/232939; G03B 13/36

(57) ABSTRACT

A shooting control method and device for a shooting control system. The shooting control method and device may include, in response to a first focusing confirmation operation, recording a first measured distance between the shooting equipment and the shooting target and a first measured rotation position of the follow focus motor; in response to a second focus confirmation operation, recording a second measured distance between the shooting equipment and the shooting target and a second measured rotation position of the follow focus motor; acquiring a real-time measured distance between the shooting equipment and the shooting target; and controlling the follow focus motor to drive the lens to focus so that the shooting target is in focus in the shooting image of the shooting equipment according to the first measured distance, the first measured rotation position, the second measured distance, the second measured rotation position, and the real-time measured distance.

### CROSS-REFERENCE TO RELATED APPLICATION

The present disclosure is a continuation of International Application No. PCT/CN2020/116854, filed on Sep. 22, 2020, the entire contents of which is incorporated herein by reference in its entirety.

### TECHNICAL FIELD

The present disclosure relates to the field of controllable technology, in particular, to a shooting control method and a shooting control device, for instance, for or including an image capture device.

### BACKGROUND

Shooting equipment may be not only integrated in a smart terminal device for shooting, but also mounted on a gimbal for shooting. Among them, in order to realize convenience of manipulation, a handheld gimbal is gradually favored by users, and a user can complete shooting anytime and anywhere by holding the handheld gimbal. In addition, since the handheld gimbal is provided with a pan/tilt portion, it can realize rotation shooting at various angles. Furthermore, the shooting image obtained is stable and the imaging effect is very good.

When the user holds the handheld gimbal and uses the shooting equipment to shoot, the user may set shooting parameters in the shooting process through a disclosure program installed in a control terminal of the handheld gimbal to meet personalized shooting required by the user. However, at present, smart shooting functions provided by the handheld gimbal are still relatively few and cannot meet the needs of users.

### SUMMARY

One embodiment of the present disclosure provides a shooting control method for a shooting control system. The shooting control system may include a handheld gimbal and a follow focus motor, the handheld gimbal may include a bearing base to carry a shooting equipment and a handheld portion, the handheld portion may include a first interaction device, and the follow focus motor may be meshed with a follow focus ring of a lens of the shooting equipment. The shooting control method may include detecting a first focus confirmation operation of a user on the first interactive device when a shooting target is in focus in a shooting image of the shooting equipment, wherein a distance between the shooting target and the shooting equipment is a first distance; in response to the first focusing confirmation operation, recording a first measured distance between the shooting equipment and the shooting target and a first measured rotation position of the follow focus motor collected by a distance sensor; detecting a second focus confirmation operation of the user on the first interactive device when the shooting target is in focus in the shooting image of the shooting equipment, wherein the distance between the shooting target and the shooting equipment is a second distance; in response to the second focus confirmation operation, recording a second measured distance between the shooting equipment and the shooting target and a second measured rotation position of the follow focus motor collected by the distance sensor; acquiring a real-time measured distance between the shooting equipment and the shooting target collected by the distance sensor; and controlling the follow focus motor to drive the lens to focus so that the shooting target is in focus in the shooting image of the shooting equipment according to the first measured distance, the first measured rotation position, the second measured distance, the second measured rotation position, and the real-time measured distance.

Another embodiment of the present disclosure is a shooting control device for a shooting control system. The shooting control system may include a handheld gimbal and a follow focus motor, the handheld gimbal may include a bearing base to carry a shooting equipment and a handheld portion, the handheld portion may include a first interaction device, and the follow focus motor may be meshed with a follow focus ring of a lens of the shooting equipment. The shooting control device may include a memory and a processor or processing circuitry. The memory may be configured to store instructions. The processor or processing circuitry may be configured to call the instructions stored in the memory to perform the following operations: detecting a first focus confirmation operation of a user on the first interactive device when a shooting target is in focus in a shooting image of the shooting equipment, wherein a distance between the shooting target and the shooting equipment is a first distance; in response to the first focusing confirmation operation, recording a first measured distance between the shooting equipment and the shooting target and a first measured rotation position of the follow focus motor collected by a distance sensor; detecting a second focus confirmation operation of the user on the first interactive device when the shooting target is in focus in the shooting image of the shooting equipment, wherein the distance between the shooting target and the shooting equipment is a second distance; in response to the second focus confirmation operation, recording a second measured distance between the shooting equipment and the shooting target and a second measured rotation position of the follow focus motor collected by the distance sensor; acquiring a real-time measured distance between the shooting equipment and the shooting target collected by the distance sensor; and controlling the follow focus motor to drive the lens to focus so that the shooting target is in focus in the shooting image of the shooting equipment according to the first measured distance, the first measured rotation position, the second measured distance, the second measured rotation position, and the real-time measured distance.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic structural diagram of a shooting system according to an embodiment of the present disclosure;

FIG. 2 is a schematic structural diagram of a handheld gimbal (which may also be referred to as a pan/tilt head) according to an embodiment of the present disclosure;

FIG. 3 is a schematic structural diagram of a shooting equipment according to an embodiment of the present disclosure;

FIG. 4 is a flowchart of a shooting control method according to an embodiment of the present disclosure;

FIGS. 5A-5D are schematic diagrams of an interface operation of the first focusing confirmation operation according to an embodiment of the present disclosure;

FIG. 6A-6B are schematic diagrams of an interface operation of the second focus confirmation operation according to an embodiment of the present disclosure;

FIG. 7 is a flowchart of a shooting control method according to an embodiment of the present disclosure;

FIGS. 8A-8D are schematic diagrams of an interface operation of a shooting control method according to an embodiment of the present disclosure;

FIG. 9 is a flowchart of a shooting control method according to an embodiment of the present disclosure;

FIGS. 10A-10D are schematic diagrams of an interface operation of a first zoom confirmation operation according to an embodiment of the present disclosure;

FIGS. 11A-11B are schematic diagrams of an interface operation of a second zoom confirmation operation according to an embodiment of the present disclosure;

FIG. 12 is a flowchart of a shooting control method according to an embodiment of this present disclosure;

FIGS. 13A-13D are schematic diagrams of an interface operation of a shooting control method according to an embodiment of the present disclosure;

FIGS. 14A-14E are schematic diagrams of an interface operation of a shooting control method according to an embodiment of the present disclosure;

FIG. 15 is a schematic structural diagram of a shooting control device according to an embodiment of the present disclosure;

FIG. 16 is a schematic structural diagram of a handheld gimbal according to an embodiment of the present disclosure; and

FIG. 17 is a schematic structural diagram of a follow focus motor according to an embodiment of the present disclosure.

### DETAILED DESCRIPTION

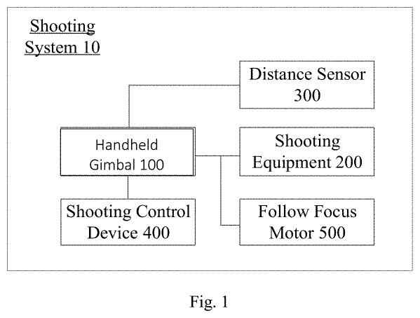

The specific embodiments of the present disclosure are further described in detail below with reference to the drawings and embodiments. The following examples are intended to illustrate the disclosure but are not intended to limit the scope of the disclosure. It should be noted that, in the case of no conflict, the features in the embodiments and the embodiments in the present disclosure could be arbitrarily combined with each other. Throughout the description of the disclosure, reference is made to FIGS. 1-17. When referring to the figures, like structures and elements shown throughout are indicated with like reference numerals. It should be understood that the dimensions of the various parts shown in the drawings are not drawn in the actual scale. Based on these embodiments of the present disclosure, all other embodiments obtained by those of ordinary skill in the art without creative work shall fall within the protection scope of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

Unless otherwise defined, all technical and scientific terms used herein have the same meaning as commonly understood by those of ordinary skill in the technical field of the present disclosure. The terms used in the specification of the present disclosure herein are only for the purpose of describing specific embodiments, and are not intended to limit the present disclosure.

The term “comprising” mentioned in the entire specification and claims is an open term, so it should be interpreted as “including but not limited to.” “Approximately” means that within an acceptable error range, those of ordinary skill in the art can solve the technical problem and basically achieve the technical effect within the certain error range.

In addition, the term “connected” or “coupled” herein includes any direct or indirect means of connection. Therefore, if it is described that a first device is connected or coupled to a second device, it means that the first device can be directly connected or coupled to the second device, or indirectly connected or coupled to the second device through other devices.

The term “and/or” used in this specification describes only an association relationship of the associated objects, which indicates that there can be three relationships. For example, the term “A1 and/or B1” may indicate three scenarios, that is, A1 existing alone, A1 and B1 existing simultaneously, and B1 existing alone. In addition, the character “/” in this text generally indicates that the associated objects before and after are in an “or” relationship.

In the description of the present disclosure, the terms “center,” “horizontal,” “vertical,” “length,” “upper,” “lower,” “front,” “back,” “vertical,” “horizontal,” “top,” “bottom,” “inner,” “outer,” “an axial direction,” “a radial direction,” “a circumferential direction,” “up,” “down,” or the like are based on the orientation or positional relationship shown in the drawings. They are used merely for convenience of description and simplifying description of the present disclosure, but not to indicate or imply that the indicated apparatus or element must have a specific orientation, or be constructed and operated in a specific orientation, therefore cannot be construed as a limitation of the present disclosure.

In addition, the terms “first” and “second” are for illustration purposes only and are not to be construed as indicating or implying relative importance or implied reference to the quantity of indicated technical features. Thus, features defined by the terms “first” and “second” may explicitly or implicitly include one or more of the features. In the description of the present disclosure, the meaning of “plural” is two or more unless otherwise specifically and specifically defined.

In the description of the specification, references made to the term “one embodiment,” “some embodiments,” and “exemplary embodiments,” “example,” and “specific example,” or “some examples” and the like are intended to refer that specific features and structures, materials or characteristics described in connection with the embodiment or example that are included in at least some embodiments or example of the present disclosure. The schematic expression of the terms does not necessarily refer to the same embodiment or example. Moreover, the specific features, structures, materials or characteristics described may be included in any suitable manner in any one or more embodiments or examples.

In order to make the purpose, technical solutions and advantages of embodiments of this disclosure clearer, the technical solutions in the embodiments of this disclosure will be described clearly and completely in conjunction with the drawings in the embodiments of this disclosure. Obviously, the described embodiments are part of the embodiments of this disclosure, not all of the embodiments. Based on the embodiments in this disclosure, all other embodiments obtained by a person of ordinary skill in the art without creative work shall fall within the protection scope of this disclosure.

It should be noted that when a component is referred to as being “fixed to” another component, it can be directly on the other component or a middle component may also exist. When a component is considered to be “connected” to another component, it can be directly connected to another component or there may be a middle component at the same time.

Unless otherwise defined, all technical and scientific terms used herein have the same meaning as commonly understood by those of ordinary skill in the technical field of this disclosure. The terminology used in the specification of the disclosure herein is only for the purpose of describing specific embodiments, and is not intended to limit the disclosure. The term “and/or” as used herein includes any and all combinations of one or more related listed items.

Some embodiments of the present disclosure provide a shooting control method and a shooting control device by adjusting parameters of a follow focus motor when the shooting equipment on the handheld gimbal and the shooting target are at different distances, so that the shooting target is in focus in the shooting image of the shooting equipment. As such, the corresponding relationship between the distance between the shooting equipment and the shooting target and the parameters of the follow focus motor when the shooting target is in focus in the shooting image of the shooting equipment is obtained. Then, based on the corresponding relationship, the parameters of the follow focus motor can be adjusted according to the real time distance between the shooting equipment and the shooting target to ensure that the shooting target is in focus in the shooting image of the shooting equipment. Such method may realize automatic focusing, simplify the user's operation, improve the user experience, and/or enrich smart shooting function of the handheld gimbal, as examples.

In addition, it is also possible to adjust the parameters of the follow focus motor when the shooting equipment on the handheld gimbal is at different distances from the shooting target, so that the size of the shooting target in the shooting screen of the shooting equipment is the same size. Accordingly, the corresponding relationship between the distance between the shooting equipment and the shooting target and the parameters of the follow focus motor when the size of the shooting target in the shooting image of the shooting equipment remains a same size is obtained. Then, according to the corresponding relationship, the parameters of the follow focus motor are adjusted according to the real time distance between the shooting equipment and the shooting target, so as to ensure that the size of the shooting target in the shooting image of the shooting equipment remains at the same size. As such, sliding zoom can be realized, a user's operation is simplified, user experience is improved, and/or smart shooting function of the handheld gimbal is enriched as examples.

FIG. 1 is a schematic structural diagram of a shooting system provided by an embodiment of the present disclosure. As shown in FIG. 1, the shooting system 10 can include a handheld gimbal 100, which may be referred to as a pan/tilt head, a shooting equipment 200 mounted on the handheld gimbal 100 and communicatively connected with the handheld gimbal 100, a distance sensor 300 relatively fixed to the shooting equipment 200, and a follow focus motor 500 carried on the handheld gimbal 100 and used to drive the shooting equipment 200 to zoom (in or out), land a shooting control device 400 used to drive the follow focus motor 500 to control the zoom of the shooting equipment 200 according to the sensing data of the distance sensor 300.

Wherein, the distance sensor 300 may be installed on the handheld gimbal 100 or installed on the shooting equipment 200, which may be a single-lens reflex camera, a non-reflex camera or a mirrorless camera. The distance sensor 300 may be an optical signal distance sensor or an ultrasonic distance sensor. For example, the distance sensor 300 can be a time of flight (TOF) sensor.

The shooting control device 400 may be independently installed or may be installed in the handheld gimbal 100, or installed in the shooting equipment 200, or installed in the follow focus motor 500, which is not limited here.

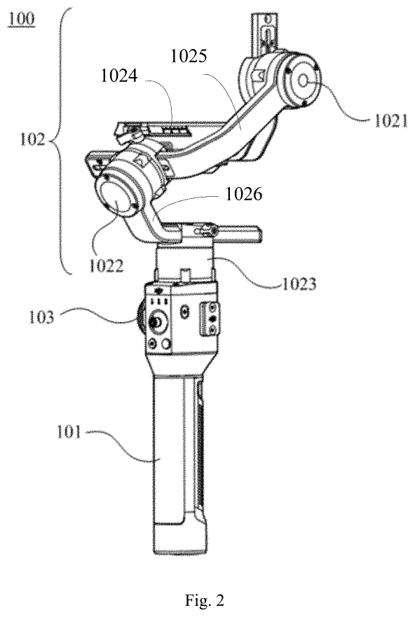

FIG. 2 is a schematic structural diagram of a handheld gimbal 100 provided by an embodiment of the disclosure. As shown in FIG. 2, the handheld gimbal 100 can include a handheld portion 101 and a pan/tilt portion 102 provided on the handheld portion 101. Among them, the pan/tilt portion 102 can be used to provide a bearer for external devices.

Optionally, the pan/tilt portion 102 includes a bearing base 1024 and three axis motors detachably connected to the bearing base 1024. The pan/tilt portion 102 can provide the bearing function through the bearing base 1024, and the shooting equipment 200 may be detachably loaded on the bearing base 1024. It can be understood that the shooting equipment 200 may be integrated with the pan/tilt portion 102. The three axis motors may include a pitch axis motor 1021, a roll axis motor 1022, and a yaw axis motor 1023, which are used to adjust the balance posture of the shooting equipment 200 mounted on the pan/tilt portion 102 to shoot high-precision stable images anytime and anywhere.

Optionally, the pitch axis motor 1021 directly drives the bearing base 1024 to adjust the posture of the bearing base 1024. The pan/tilt portion 102 includes a first axis arm 1025 supporting the pitch axis motor 1021 and a second axis arm 1026 supporting the roll axis motor 1022. The first axis arm 1025 is also connected with the roll axis motor 1022 and is directly driven by the roll axis motor 1022. The second axis arm 1026 is also connected with the yaw axis motor 1023 and is directly driven by the yaw axis motor 1023. The handheld portion 101 supports the yaw axis motor 1023.

Optionally, an inertial measured unit (IMU) is also provided on the pan/tilt portion 102. The IMU may be, for example, at least one of an accelerometer or a gyroscope. The IMU can be used to measure the posture and acceleration of the pan/tilt portion 102, so as to adjust the posture of the pan/tilt portion 102 according to the measured posture. In one embodiment, the handheld portion 101 is also provided with an IMU, for example, which includes at least one of an accelerometer or a gyroscope. The IMU may be used to measure the posture and acceleration of the handheld portion 101, so as to adjust the posture of the pan/tilt portion 102 according to the measured posture of the handheld portion 101 and the measured posture of the pan/tilt portion 102.

Optionally, a focusing wheel 103 is provided on the handheld portion 101, and the focusing wheel 103 can be used to adjust the shooting parameters of the shooting equipment 200 mounted on the pan/tilt portion 102. Alternatively, the handheld gimbal 100 is electrically connected to the follow focus motor 500 matched with the focus wheel 103. The focus wheel 103 can be used to control the follow focus motor 500 so as to adjust the shooting parameters of the shooting equipment 200 mounted on the pan/tilt portion 102 through the follow focus motor 500.

Optionally, the handheld portion 101 is also provided with a touch display screen. The real-time view image acquired by the shooting equipment 200 can be transmitted to the touch display screen on the handheld portion 101 for display. The user can manipulate the touch display screen on the handheld portion 101 to select or determine the target to be photographed by the shooting equipment 200, or select or confirm related parameters, and so on.

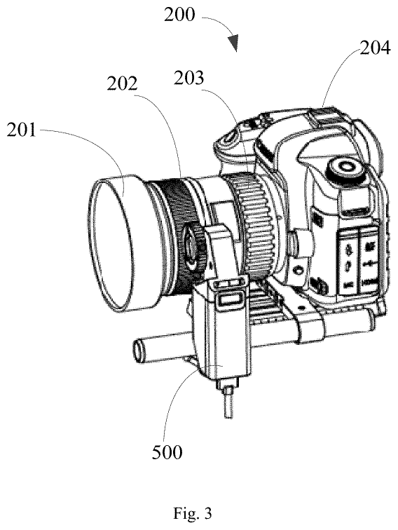

FIG. 3 is a schematic structural diagram of a shooting equipment provided by an embodiment of the disclosure. The shooting equipment 200 is provided with a follow focus ring 202 (also referred to as a focus ring) for adjusting the focus of the lens 201. The follow focus motor 500 is meshed with the follow focus ring 202 so as to drive the follow focus ring 202 to rotate to adjust the focus of the lens 201. The shooting equipment 200 is provided with a zoom ring 203 for adjusting the zoom of the lens 201. The follow focus motor 500 is meshed with the zoom ring 203 so as to drive the zoom ring 203 to rotate to adjust the zoom of the lens 201.

The follow focus motor 500 can be detachably mounted on the bearing base 1024 of the pan/tilt portion 102, or the follow focus motor 500 and the bearing base 1024 of the pan/tilt portion 102 are integrally arranged.

When the user needs to use the shooting equipment 200 for follow focus or sliding zoom shooting, a distance sensor can be detachably mounted on the shooting equipment 200 or on the handheld gimbal 100, so that the distance sensor and the shooting equipment 200 are relatively fixed. When the distance sensor is detachably installed on the shooting equipment 200, the distance sensor can be installed on the hot shoe 204 of the shooting equipment 200. When the distance sensor is detachably installed on the handheld head 100, the distance can be installed on the bearing base 1024 of the handheld gimbal 100. The real-time distance between the shooting target and the shooting equipment 200 can be obtained through the distance sensor. Then, the follow focus motor 500 can be controlled to drive the lens 201 to focus according to the real-time distance so that the shooting target is in focus in the shooting image of the shooting equipment 200. Alternatively, the follow focus motor 500 can be further controlled to drive the lens 201 to zoom according to the real-time distance, so that the size of the shooting target in the shooting image of the shooting equipment 200 is adjusted to be the target size.

Optionally, the shooting target being in focus in the shooting image of the shooting equipment 200 may be set by the user. In one embodiment, the user obtains a live view image of the shooting target through the shooting equipment 200 and adjusts the lens 201 so that the shooting target in the live view screen is in focus in the shooting image of the shooting equipment 200. Then, by manipulating the shooting equipment 200 or the handheld gimbal 100 connected in communication with the shooting equipment 200, the user issues an instruction to the shooting equipment 200 so that the shooting equipment 200 determines that the shooting target is in focus in the shooting image of the shooting equipment 200 according to the instruction.

Optionally, the user obtains the live view image of the shooting target through the shooting equipment 200 and adjusts the focus wheel 103 on the handheld portion 101 installed on the handheld gimbal 100 so that the shooting target in the live view screen is in focus in the shooting image of the shooting equipment 200. Then, the user issues an instruction to the shooting equipment 200 by manipulating the shooting equipment 200 or the handheld gimbal 100, so that the shooting equipment 200 determines that the shooting target is in focus in the shooting image of the shooting equipment 200 according to the instruction.

Optionally, the target size of the shooting target in the shooting image of the shooting equipment 200 is set by the user. In one embodiment, the user obtains the live view image of the shooting target through the shooting equipment 200 and adjusts the lens 201 so that the size of the area where the shooting target is located in the live view screen is a preset target size. Then, the user issues an instruction to the shooting equipment 200 by manipulating the shooting equipment 200 or the handheld gimbal 100 connected in communication with the shooting equipment 200, so that the shooting equipment 200 determines the size of the shooting target in the shooting image of the shooting equipment 200 as the target size according to the instruction.

Alternatively, the user obtains the live view image of the shooting target through the shooting equipment 200 and adjusts the focus wheel 103 provided on the handheld portion 101 installed on the handheld gimbal 100 so that the size of the area where the shooting target is located in the live view screen is the preset target size. Then, the user issues an instruction to the shooting equipment 200 by manipulating the shooting equipment 200 or the handheld gimbal 100, so that the shooting equipment 200 determines the size of the shooting target in the shooting image of the shooting equipment 200 as the target size according to the instruction.

It is understandable that the shooting system, the shooting equipment, the handheld gimbal 100 and the aforementioned naming of the components of the shooting equipment and the handheld gimbal 100 in FIG. 1, FIG. 2, and FIG. 3 are only for the purpose of identification, and do not therefore limit the embodiments of the present disclosure.

The following method embodiments can be executed by a handheld gimbal or a follow focus motor according to one or more embodiments of the present disclosure. The following uses the implementation of a handheld gimbal as an example for description.

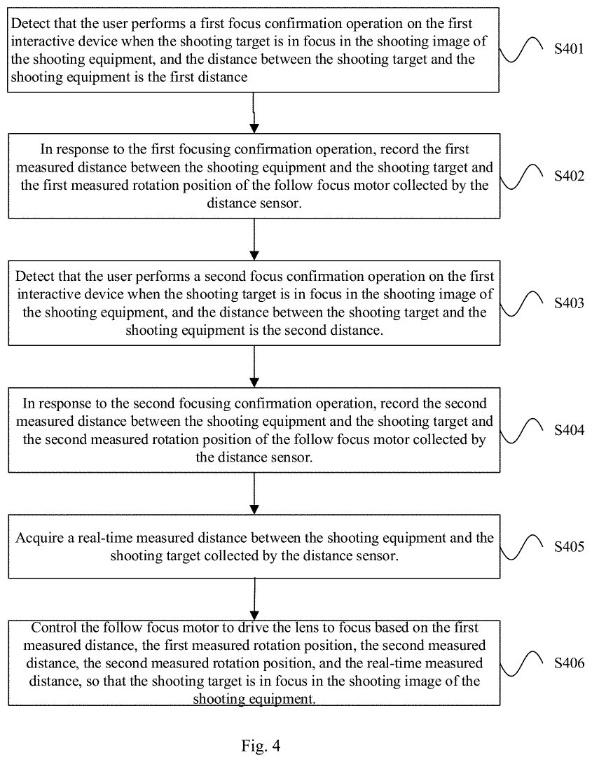

FIG. 4 is a flowchart of a shooting control method provided by an embodiment of the disclosure. As shown in FIG. 4, the method of this embodiment can be applied to a shooting control system, which includes a handheld gimbal and a follow focus motor. The handheld gimbal includes a bearing base and a handheld portion for carrying the shooting equipment. Please refer to the examples shown in FIGS. 1 to 3 above. Wherein, the handheld portion includes a first interaction device, and the follow focus motor is meshed with the follow focus ring of the lens of the shooting equipment. The execution subject of the method in this embodiment may be a handheld gimbal, and the method in this embodiment may include the following steps:

S401. Detect that the user performs a first focus confirmation operation on the first interactive device when the shooting target is in focus in the shooting image of the shooting equipment, and the distance between the shooting target and the shooting equipment is the first distance.

In one embodiment, the shooting equipment can obtain a live view image of the shooting target and display the live view image on a display screen (such as a touch display screen). When the distance between the shooting target and the shooting equipment is the first distance and when the user judges that the shooting target is in focus in the shooting image of the shooting equipment by observing the live view screen, that is, the user judges that the shooting target is clearly imaged in the shooting image of the shooting equipment by watching the live view screen, the user performs a focus confirmation operation on the first interactive device, here referred to as the first focus confirmation operation, to confirm that the current shooting target is in focus in the shooting image of the shooting equipment. Correspondingly, the handheld gimbal can detect the first focus confirmation operation of the user on the first interaction device (such as a touch display screen). Wherein, when the user's first focusing confirmation operation on the first interaction device is detected, the distance between the shooting target and the shooting equipment is the first distance.

S402. In response to the first focusing confirmation operation, record the first measured distance between the shooting equipment and the shooting target and the first measured rotation position of the follow focus motor collected by the distance sensor.

In one embodiment, in response to the detected first focusing confirmation operation, the measured distance between the shooting equipment and the shooting target collected by the distance sensor is recorded, here referred to as the first measured distance, and the measured rotation position of the follow focus motor, which is called the first measured rotation position here, is also recorded.

The first measured distance is the distance collected by the distance sensor when the distance between the shooting target and the shooting equipment is the first distance. The first measured rotation position is the rotation position of the follow focus motor measured when the distance between the shooting target and the shooting equipment is the first distance.

S403: Detect that the user performs a second focus confirmation operation on the first interactive device when the shooting target is in focus in the shooting image of the shooting equipment, and the distance between the shooting target and the shooting equipment is the second distance.

In one embodiment, when the distance between the shooting target and the shooting equipment is the second distance and when the user judges that the shooting target is in focus in the shooting image of the shooting equipment by watching the live view, that is, the user judges that the shooting target is clearly imaged in the shooting image of the shooting equipment by watching the live view screen, the user performs a focus confirmation operation on the first interactive device, here referred to as the second focus confirmation operation, to confirm that the current shooting target is in focus in the shooting image of the shooting equipment. Correspondingly, the handheld gimbal can detect the second focus confirmation operation of the user on the first interactive device (such as a touch display screen). Wherein, when the second focusing confirmation operation of the first interaction device by the user is detected, the distance between the shooting target and the shooting equipment is the second distance.

S404. In response to the second focusing confirmation operation, record the second measured distance between the shooting equipment and the shooting target and the second measured rotation position of the follow focus motor collected by the distance sensor.

In one embodiment, in response to the detected second focus confirmation operation, the measured distance between the shooting equipment and the shooting target collected by the distance sensor, here referred to as the second measured distance, is recorded. Furthermore, the measured rotation position of the follow focus motor, here referred to as the second measured rotation position, is also recorded.

The second measured distance is the distance collected by the distance sensor when the distance between the shooting target and the shooting equipment is the second distance. The second measured rotation position is the rotation position of the follow focus motor measured when the distance between the shooting target and the shooting equipment is the second distance.

S405: Acquire a real-time measured distance between the shooting equipment and the shooting target collected by the distance sensor.

In one embodiment, after acquiring the measured distance between the shooting equipment and the shooting target and the measured rotation position of the follow focus motor collected by the distance sensor at different distances between the shooting target and the shooting equipment, the real-time measured distance between the shooting equipment and the shooting target collected by the distance sensor is acquired.

For example, it is detected that the user starts the follow focus shooting confirmation operation of the first interactive device, and in response to the start of the follow focus shooting confirmation operation, the real-time measured distance between the shooting equipment and the shooting target collected by the distance sensor is acquired.

S406. Control the follow focus motor to drive the lens to focus based on the first measured distance, the first measured rotation position, the second measured distance, the second measured rotation position, and the real-time measured distance, so that the shooting target is in focus in the shooting image of the shooting equipment.

In one embodiment, based on the first measured distance, the first measured rotation position, the second measured distance, the second measured rotation position, and the real-time measured distance, the follow focus motor is controlled to drive the lens to focus so that the shooting target is in focus in the shooting image of the shooting equipment. For example, according to the first measured distance, the first measured rotation position, the second measured distance, and the second measured rotation position, the corresponding relationship between the measured distance between the shooting equipment and the shooting target and the rotation position of the follow focus motor when the shooting target is in focus in the shooting image of the shooting equipment can be obtained. Then, according to the corresponding relationship and the real-time measured distance, the rotation position of the follow focus motor when the shooting target is in focus in the shooting image of the shooting equipment under the real-time measured distance can be determined. Then, the position of the follow focus motor is rotated to the determined rotation position. As such, the follow focus motor drives the lens to focus, so that the shooting target is in focus in the shooting image of the shooting equipment.

Optionally, the shooting method can not only controls the follow focus motor to drive the lens to focus, but can also control the shooting equipment to shoot images so as to obtain an image of the shooting target in focus. Optionally, the shooting method may not only controls the follow focus motor to drive the lens to focus, but may also control the shooting equipment to record video so as to obtain a video where the shooting target is always in focus.

The shooting control method of this embodiment can obtain the measured distance between the shooting target and the shooting equipment and the measured rotation position of the follow focus motor collected by the distance sensor by detecting the user's focus confirmation operation on the first interactive device when the shooting target is at different distances from the shooting equipment. Then, the real-time measured distance between the shooting target and the shooting equipment collected by the distance sensor can be obtained. According to the real-time measured distance, and the measured distances and the measured rotation positions of the follow focus motor when the shooting target is at different distances from the shooting equipment collected by the distance sensor, the follow focus motor can be controlled to drive the lens to focus so as to make the shooting target is in focus in the shooting image of the shooting equipment. As such, according to the real-time distance between the shooting target and the shooting equipment, automatic follow focus shooting can be realized, which can simplify the user's operation and/or improve the user's experience.

In some embodiments, the handheld portion of the handheld gimbal can further include a second interactive device, and the user can perform operations on the second interactive device such as focusing adjustment operations. Correspondingly, when the shooting equipment is at a first distance from the shooting target, the user can perform a focus adjustment operation on the second interactive device, herein referred to as a first focus adjustment operation. The first focusing adjustment operation can be used to adjust the shooting target to be in focus in the shooting image. Correspondingly, the handheld gimbal can detect the user's first focus adjustment operation on the second interactive device, and can control the follow focus motor to drive the lens to focus according to the first focus adjustment operation so as to adjust the shooting target to be in focus in the shooting image of the shooting equipment. Then, when the shooting target is in focus in the shooting image of the shooting equipment, the user can perform the above-mentioned first focus confirmation operation on the first interactive device.

Optionally, when the shooting equipment is at a second distance from the shooting target, the user can perform a focus adjustment operation on the second interactive device, which is referred to herein as a second focus adjustment operation. The second focusing adjustment operation can be used to adjust the shooting target to be in focus in the shooting image. Correspondingly, the handheld gimbal can detect the second focus adjustment operation of the user on the second interactive device, and control the follow focus motor to drive the lens to focus according to the second focus adjustment operation so as to adjust the shooting target to be in focus in the shooting image of the shooting equipment. Then, when the shooting target is in focus in the shooting image of the shooting equipment, the user can perform the above-mentioned second focus confirmation operation on the first interactive device.

Therefore, in these embodiments, the user can perform a focus adjustment operation on the second interaction device, so that when the shooting equipment is at different distances from the shooting target, the shooting target can be adjusted to be in focus in the shooting image of the shooting equipment.

In one embodiment, the aforementioned second interaction device can include a focus wheel, such as the focus wheel 103 in FIG. 2. Correspondingly, when the user needs to adjust the shooting target to the in-focus state in the shooting image of the shooting equipment, the user can perform a rotation operation on the focus wheel 103. The rotation of the focus wheel 103 drives the follow focus motor 500 to rotate, and the rotation of the follow focus motor 500 drives the lens to focus.

When the shooting equipment is at a first distance from the shooting target, the user can perform a rotating operation on the focus wheel 103, which is referred to herein as the first rotation operation. Correspondingly, the handheld gimbal 100 detects the user's first rotation operation on the focus wheel 103, and controls the follow focus motor 500 to drive the lens to focus according to the detected first rotation operation so as to adjust the shooting target to an in-focus state in the shooting image of the shooting equipment 200.

Optionally, when the shooting equipment 200 is at a second distance from the shooting target, the user can perform a rotating operation on the focus wheel 103, which is referred to herein as a second rotation operation. Correspondingly, the handheld gimbal 100 detects the user's second rotation operation on the focus wheel 103 and, according to the detected second rotation operation, controls the follow focus motor 500 to drive the lens to focus so as to adjust the shooting target to an in-focus state in the shooting image of the shooting equipment 200.

Therefore, in this embodiment, the user performs rotating operations on the focus wheel 103, so that when the shooting equipment 200 and the shooting target are at different distances, the shooting target can be adjusted to the in-focus state in the shooting image of the shooting equipment 200.

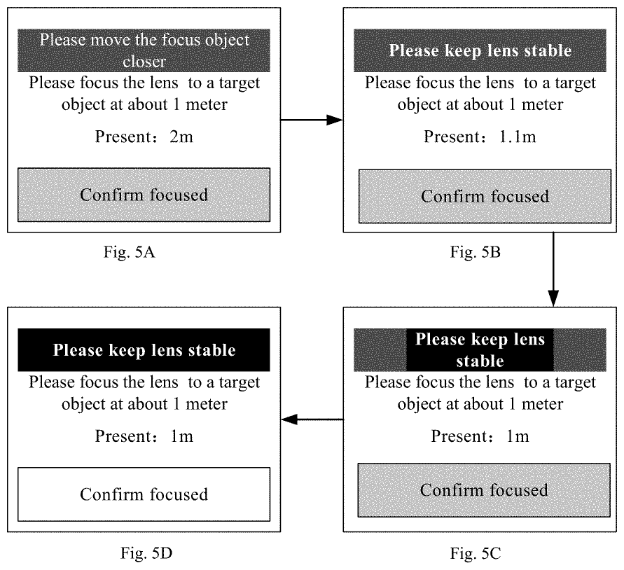

In one embodiment, the first interaction device is a touch display screen. The handheld gimbal 100 in this embodiment can also control the touch display screen to display first distance prompt information. The first distance prompt information is used to instruct the user to focus the shooting equipment to a shooting target about a first reference distance away from the shooting equipment. For example, as shown in FIG. 5A, the first reference distance is 1 meter, and the first distance prompt information can be used to instruct the user to focus the lens of the shooting equipment to a target object at about 1 meter away. Among them, the distance sensor can collect the measured distance between the shooting equipment and the shooting target. Optionally, the handheld gimbal can also control the touch display screen to display the measured distance collected by the distance sensor, such as 2 meters in FIG. 5A. The handheld gimbal can determine the deviation between the first reference distance and the measured distance collected by the distance sensor, and determine whether the deviation is greater than a preset deviation threshold. If the deviation between the first reference distance and the measured distance collected by the distance sensor is greater than the preset deviation threshold, the touch display screen can be controlled to display first distance adjustment information prompting the user to adjust the distance between the shooting equipment and the shooting target according to the deviation. For example, as shown in FIG. 5A, the first distance adjustment information may prompt the user to move the focus object (shooting target) closer, and the user may move the shooting equipment closer to the shooting target according to the first distance adjustment information. If the deviation between the first reference distance and the measured distance collected by the distance sensor is less than or equal to the preset deviation threshold, can mean that the shooting equipment is at about a first reference distance away from the shooting target. At this time, the shooting equipment is at the first distance away from the shooting target.

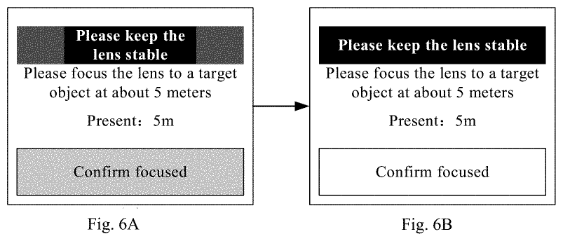

In one embodiment, the first interaction device is a touch display screen. The handheld gimbal in this embodiment can also control the touch display screen to display second distance prompt information, which can be used to instruct the user to focus the shooting equipment to a shooting target at about a second reference distance away from the shooting equipment. For example, the second reference distance is 5 meters. As shown in FIG. 6A and FIG. 6B, the second distance prompt information can be used to instruct the user to focus the lens of the shooting equipment to a target object at about 5 meters away. Among them, the distance sensor can collect the measured distance between the shooting equipment and the shooting target. Optionally, the handheld gimbal can also control the touch display screen to display the measured distance collected by the distance sensor. The handheld gimbal can determine the deviation between the second reference distance and the measured distance collected by the distance sensor, and determine whether the deviation is greater than a preset deviation threshold. If the deviation between the second reference distance and the measured distance collected by the distance sensor is greater than the preset deviation threshold, the touch screen can be controlled to display the second distance adjustment information prompting the user to adjust the distance between the shooting equipment and the shooting target according to the deviation. If the deviation between the second reference distance and the measured distance collected by the distance sensor is less than or equal to the preset deviation threshold, this can mean that the shooting equipment is at about a second reference distance from the shooting target. At this time, the shooting equipment is at the second distance from the shooting target.

Therefore, this embodiment can display the distance prompt information for instructing the user to focus the lens of the shooting equipment to the shooting target at about different reference distances through the touch display screen, and detect the measured distance between the shooting equipment and the shooting target through the distance sensor. According to the measured distance and the reference distance, the touch display screen displays the distance adjustment information prompting the user to adjust the distance between the shooting equipment and the shooting target, so that the user can adjust the distance between the shooting equipment and the shooting target according to the distance adjustment information to ensure the distance between the shooting equipment and the shooting target is close to the above-mentioned reference distance. This can allow the user to perform a focus confirmation operation when the distance is close to the reference distance.

In one embodiment, the first interaction device is a touch display screen. A possible implementation of the above S401 is: controlling the touch display screen to display the first focus confirmation icon, and then detecting that the user performs the first focus confirmation operation on the first focus confirmation icon when the shooting target is in the focus state in the shooting image of the shooting equipment.

As shown in FIG. 5D, the first focus confirmation icon is the “confirm focused” icon displayed in FIG. 5D. If the user observes the shooting screen of the shooting equipment and determines that the shooting target is in focus in the shooting image of the shooting equipment, the user can perform the first focus confirmation operation on the first focus confirmation icon. That is, the user can perform a click operation on the “confirm focused” icon shown in FIG. 5D. Correspondingly, the handheld gimbal detects the user's click operation on the “confirm focused” icon displayed on the touch screen.

A possible implementation of the above S403 is: controlling the touch display screen to display the second focus confirmation icon, and then detecting that the user performs a second focus confirmation operation on the second focus confirmation icon when the shooting target is in a focus state in the shooting image of the shooting equipment.

As shown in FIG. 6B, the second focus confirmation icon is the “confirm focused” icon displayed in FIG. 6B. If the user observes the shooting screen of the shooting equipment and determines that the shooting target is in focus in the shooting image of the shooting equipment, the user can perform the second focus confirmation operation on the second focus confirmation icon. That is, the user can perform a click operation on the “confirm focused” icon shown in FIG. 6B. Correspondingly, the handheld gimbal can detect that the user clicks on the “confirm focused” icon displayed on the touch screen.

Optionally, when the distance between the shooting equipment and the shooting target is the first distance, it also can be determined whether the time period during which the shooting equipment remains stable is less than a preset time period. If the time period during which the shooting equipment remains stable is greater than or equal to the preset time period, the first focus confirmation icon can be adjusted from the non-responsive state to the responsive state. If the time period that the shooting equipment remains stable is less than the preset time period, the touch screen can be controlled to display a prompt message for instructing the user to keep the shooting equipment stable, and at the same time, the first focus confirmation icon is set to a non-responsive state.

In one embodiment, as shown in FIG. 5B, if the deviation between the first reference distance and the measured distance between the shooting equipment and the shooting target changes from greater than the preset distance deviation threshold to less than or equal to the preset distance deviation threshold, it can indicate that the distance between the shooting equipment and the shooting target is close to the first reference distance. At this time, the distance between the shooting equipment and the shooting target is the first distance. At the same time, the touch screen can be controlled to display a prompt message for instructing to keep the shooting equipment stable, and shows that the first focus confirmation icon is at a non-responsive state. As shown in FIG. 5B, the “confirm focused” icon is a grayscale icon. The user can keep the shooting equipment stable according to the prompt information. When the handheld gimbal detects that the shooting equipment is stable, it starts to count the time period the shooting equipment remains stable, and judges whether the time period the shooting equipment remains stable is less than the preset time period. If the shooting equipment remains stable for less than the preset time period, the touch display screen can be controlled to continue to display the first focus confirmation icon as non-responsive. Optionally, the touch display screen can be controlled to display the length of time the shooting equipment remains stable. For example, a progress bar in the preset time period can be displayed for the length of time the shooting equipment remains stable, as shown in FIG. 5C. If the shooting equipment remains stable for a time period greater than or equal to the preset time period, the first focus confirmation icon displayed on the touch screen can be adjusted from a non-responsive state to a responsive state. As shown in FIG. 5D, the “confirm focused” icon is a lit icon.

Optionally, when the distance between the shooting equipment and the shooting target is the second distance, it also can be determined whether the time period during which the shooting equipment remains stable is less than a preset time period. If the time period during which the shooting equipment remains stable is greater than or equal to the preset time period, the second focus confirmation icon can be adjusted from the non-responsive state to the responsive state, as shown in FIG. 6B. If the time period the shooting equipment remains stable is less than the preset time period, the touch screen can be controlled to display a prompt message for instructing to keep the shooting equipment stable, and the second focus confirmation icon is set to a non-responsive state, as shown in FIG. 6A.

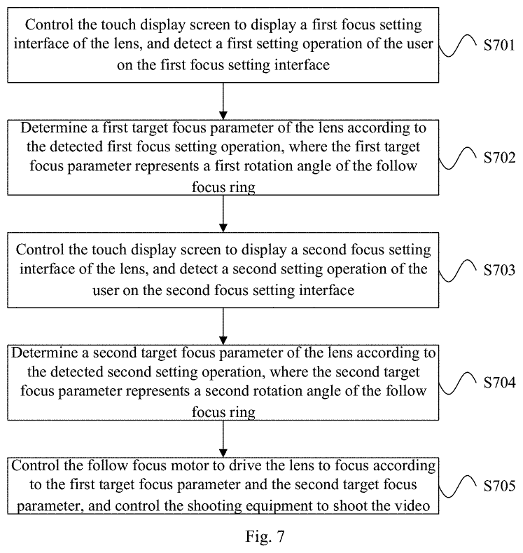

FIG. 7 is a flowchart of a shooting control method provided by an embodiment of the present disclosure. As shown in FIG. 7, the method of this embodiment can be applied to a shooting control system, which includes a handheld gimbal and a follow focus motor. The handheld gimbal includes a bearing base and a handheld portion for carrying the shooting equipment. Please refer to the examples shown in FIGS. 1 to 3 above. Among them, the handheld portion includes a touch display screen, and the follow focus motor is meshed with the follow focus ring of the lens of the shooting equipment. The execution subject of the method in this embodiment may be a handheld gimbal, and the method in this embodiment may include:

S701. Control the touch display screen to display a first focus setting interface of the lens, and detect a first setting operation of the user on the first focus setting interface.

S702. Determine a first target focus parameter of the lens according to the detected first setting operation, where the first target focus parameter represents a first rotation angle of the follow focus ring.

In this embodiment, the first focus setting interface of the lens is displayed on the touch screen controlled by the handheld gimbal. The first focus setting interface can be used to set the focus parameters of one point. Then, the user can perform a focus parameter setting operation on the first focus setting interface, which is referred to herein as a first setting operation. Correspondingly, the handheld gimbal can detect the user's first setting operation on the first focus setting interface, and then determine the target focus parameter of the lens of the shooting equipment according to the detected first setting operation, which is referred to herein as the first target focus parameter. The target focus parameter can be used to characterize the first rotation angle of the follow focus ring.

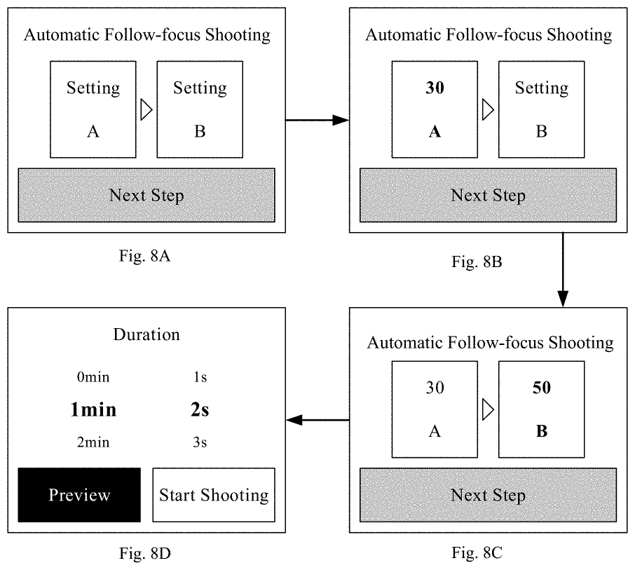

FIG. 8A shows an exemplary interface for setting the focus parameters of two points, point A and point B respectively, which represents the change of the focus parameter of point A to the focus parameter of point B. When the user clicks the setting icon of point A or the “Next Step” icon shown in FIG. 8A, the touch display screen displays the interface as shown in FIG. 8B. FIG. 8B shows the focus setting interface of point A, which is the first focus setting interface described above. The user can set the interface shown in FIG. 8B, such as sliding up and down or left and right on the focal length value icon corresponding to point A to set the focal length required by the user. The size of this focal length can represent the rotation angle of the follow focus ring. For example, when the user observes that the shooting target is in focus in the shooting image of the shooting equipment, the user stops sliding. Correspondingly, the handheld gimbal can determine the first target focal length of the lens according to the user's setting operation on the interface shown in FIG. 8B, for example, 30.

S703. Control the touch display screen to display a second focus setting interface of the lens, and detect a second setting operation of the user on the second focus setting interface.

S704. Determine a second target focus parameter of the lens according to the detected second setting operation, where the second target focus parameter represents a second rotation angle of the follow focus ring.

In this embodiment, the second focus setting interface of the lens is displayed on the touch display screen controlled by the handheld gimbal. The second focus setting interface can be used to set the focus parameter of another point, and then the user performs the focus parameter setting operation on the second focus setting interface, which is herein referred to as the second setting operation. Correspondingly, the handheld gimbal can detect the user's second setting operation on the second focus setting interface, and then determine the target focus parameter of the lens of the shooting equipment according to the detected second setting operation, which is referred to herein as the second target focus parameter. The second target focus parameter can be used to characterize the second rotation angle of the follow focus ring.

As shown in FIG. 8B, after the user completes the setting operation of point A, when the user clicks the setting icon of point B or the “Next Step” icon shown in FIG. 8B, the handheld gimbal can control the touch screen to display the interface shown in FIG. 8C. FIG. 8C shows the focus setting interface of point B, which is the second focus setting interface described above. The user can perform a setting operation on the interface shown in FIG. 8C, such as sliding up and down or left and right on the focal length value icon corresponding to point B to set the focal length required by the user. The size of this focal length can represent the rotation angle of the follow focus ring. For example, when the user observes that the shooting target is in focus in the shooting image of the shooting equipment, the user stops sliding. Correspondingly, the handheld gimbal can determine the second target focal length of the lens according to the user's setting operation on the interface shown in FIG. 8C, for example, 50.

S705: Control the follow focus motor to drive the lens to focus according to the first target focus parameter and the second target focus parameter, and control the shooting equipment to shoot the video.

In this embodiment, since the first target focus parameter represents the first rotation angle of the follow focus ring, and the second target focus parameter represents the second rotation angle of the follow focus ring, the first rotation angle of the follow focus ring is determined according to the first target focus parameter, and the second rotation angle of the follow focus ring is determined according to the second target focus parameter. Then, according to the follow focus ring from the first rotation angle to the second rotation angle, the follow focus motor can be controlled to rotate. In the process that the follow focus motor rotates and drives the follow focus ring to rotate, the lens is driven to focus. At the same time, the shooting equipment can be controlled to shoot the video, and the shooting target in the obtained video can be in focus.

In these embodiments, different focus setting interfaces are displayed through the touch display screen of the handheld gimbal, and different target focus parameters can be determined according to the user's setting operations on each of the focus setting interfaces. Then, according to each target focus parameter, such as in the process of changing from one target focus parameter to another target focus parameter, the follow focus motor can be controlled to drive the lens to focus, and the shooting equipment can be controlled to shoot video, so that the shooting target is in focus on the shooting screen of the shooting equipment. Thus, according to the focus parameters set by the user, automatic follow-focus shooting can be realized, the user's operation can be simplified, and/or the user's experience can be improved.

Based on the embodiment shown in FIG. 7, the method of this embodiment may further include: detecting a video duration setting operation of the user on the touch screen, and determining the target video duration according to the detected video duration setting operation. Correspondingly, a possible implementation of S705 is: controlling the follow focus motor to drive the lens to focus and controlling the shooting equipment to shoot the video according to the first target focus parameter, the second target focus parameter, and the target video duration. In this embodiment, the duration from the first target focus parameter to the second target focus parameter is the aforementioned target video duration. The obtained video can be a video whose duration is the target video duration during which the first target focus parameter changes to the second target focus parameter.

In one embodiment, the handheld gimbal can control the touch display screen to display the video duration setting interface. For example, as shown in FIG. 8C, when the user clicks on the “Next Step” icon in the interface shown in FIG. 8C, the handheld gimbal can control the touch screen to display the video duration setting interface. For example, FIG. 8D shows the video duration setting interface. The user can perform a setting operation on the interface shown in FIG. 8D, for example, slide up and down on the minute value icon and the second value icon on the interface to set the duration. For example, when the user stops sliding, correspondingly, the handheld gimbal can determine the video duration according to the user's setting operation on the interface shown in FIG. 8D, for example, 1 minute and 2 seconds. When the user clicks on the “Start Shooting” icon in the interface shown in FIG. 8D, the handheld gimbal will control the follow focus motor according to the focal length 30 and the focal length 50 to drive the lens to focus, and control the shooting equipment to take 1 minute 2 seconds of video. Therefore, through the above method, it is possible to realize automatic follow-focus shooting within the video duration set by the user.

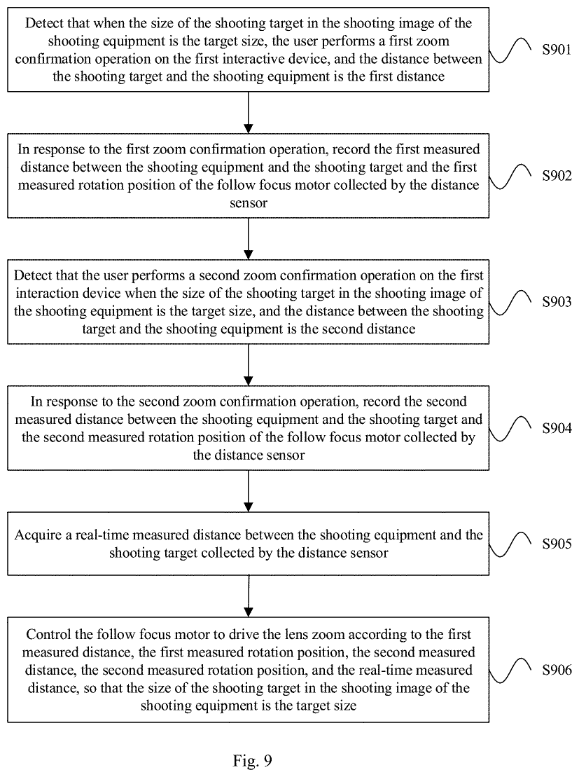

FIG. 9 is a flowchart of a shooting control method according to an embodiment of the present disclosure. As shown in FIG. 9, the method of this embodiment can be applied to a shooting control system, which includes a handheld gimbal and a follow focus motor. The handheld gimbal includes a bearing base and a handheld portion for carrying the shooting equipment. Please refer to the examples shown in FIGS. 1-3. Wherein, the handheld portion includes a first interaction device, and the follow focus motor is meshed with the zoom ring of the lens of the shooting equipment. The execution subject of the method in this embodiment may be a handheld gimbal, and the method in this embodiment may include:

S901. Detect that when the size of the shooting target in the shooting image of the shooting equipment is the target size, the user performs a first zoom confirmation operation on the first interactive device, and the distance between the shooting target and the shooting equipment is the first distance.

In this embodiment, the shooting equipment can obtain a live view image of the shooting target, and display the live view image on a display screen (such as a touch screen). When the distance between the shooting target and the shooting equipment is the first distance and when the user judges that the size of the shooting target in the shooting image of the shooting equipment is the target size by watching the live view screen, the user performs a zoom confirmation operation on the first interactive device, which is herein referred to as the first zoom confirmation operation, to confirm that the size of the current shooting target in the shooting image of the shooting equipment is the target size. Correspondingly, the handheld gimbal can detect the user's first zoom confirmation operation on the first interactive device (such as a touch screen). Wherein, when the user's first zoom confirmation operation on the first interaction device is detected, the distance between the shooting target and the shooting equipment is the first distance.

Optionally, the target size is set by the user. For example, the user can judge whether the size of the shooting target in the shooting image of the shooting equipment is the target size by observing the number of grids occupied by the shooting target in the live view screen displayed on the display screen.

S902. In response to the first zoom confirmation operation, record the first measured distance between the shooting equipment and the shooting target and the first measured rotation position of the follow focus motor collected by the distance sensor.

In this embodiment, in response to the detected first zoom confirmation operation, the measured distance between the shooting equipment and the shooting target collected by the distance sensor is recorded, which is herein referred to as the first measured distance. The measured rotation position of the follow focus motor is also recorded, which is herein referred to as the first measured rotation position.

The first measured distance is the distance collected by the distance sensor when the distance between the shooting target and the shooting equipment is the first distance. The first measured rotation position is the rotation position of the follow focus motor measured when the distance between the shooting target and the shooting equipment is the first distance.

S903. Detect that the user performs a second zoom confirmation operation on the first interaction device when the size of the shooting target in the shooting image of the shooting equipment is the target size, and the distance between the shooting target and the shooting equipment is the second distance.

In this embodiment, when the distance between the shooting target and the shooting equipment is the second distance, and when the user judges that the size of the shooting target in the shooting image of the shooting equipment is the target size by observing the live view screen, the user can perform a zoom confirmation operation on the first interactive device, which is herein referred to as a second zoom confirmation operation, to confirm that the size of the current shooting target in the shooting image of the shooting equipment is the target size. Correspondingly, the handheld gimbal can detect the second zoom confirmation operation of the user on the first interactive device (such as a touch screen). Wherein, when the second zoom confirmation operation of the first interactive device by the user is detected, the distance between the shooting target and the shooting equipment is the second distance.

S904. In response to the second zoom confirmation operation, record the second measured distance between the shooting equipment and the shooting target and the second measured rotation position of the follow focus motor collected by the distance sensor.

In this embodiment, in response to the detected second zoom confirmation operation, the measured distance between the shooting equipment and the shooting target collected by the distance sensor is recorded, here referred to as the second measured distance, and the follow focus motor is also recorded. The measured rotational position is referred to here as the second measured rotational position.

The second measured distance is the distance collected by the distance sensor when the distance between the shooting target and the shooting equipment is the second distance. The second measured rotation position is the rotation position of the follow focus motor measured when the distance between the shooting target and the shooting equipment is the second distance.

S905: Acquire a real-time measured distance between the shooting equipment and the shooting target collected by the distance sensor.

In this embodiment, after acquiring the measured distance between the shooting equipment and the shooting target collected by the distance sensor and the measured rotation position of the follow focus motor when the shooting target is at different distances from the shooting equipment, the real-time measured distance between the shooting equipment and the shooting target collected by the distance sensor is obtained.

For example, it is detected that the user starts the zoom shooting confirmation operation, and in response to the start of the zoom shooting confirmation operation, the real-time measured distance between the shooting equipment and the shooting target collected by the distance sensor can be acquired.

S906. Control the follow focus motor to drive the lens zoom according to the first measured distance, the first measured rotation position, the second measured distance, the second measured rotation position, and the real-time measured distance, so that the size of the shooting target in the shooting image of the shooting equipment is the target size.

In this embodiment, the follow focus motor can be controlled to drive the lens to zoom according to the first measured distance, the first measured rotation position, the second measured distance, the second measured rotation position, and the real-time distance, so that the size of the shooting target in the shooting image of the shooting equipment is the target size. For example, according to the first measured distance, the first measured rotation position, the second measured distance, and the second measured rotation position, the corresponding relationship between the measured distance between the shooting equipment and the shooting target and the rotation position of the follow focus motor when the size of the shooting target in the shooting image of the shooting equipment is the target size can be obtained. Then, according to the corresponding relationship and the real-time measured distance, the rotation position of the follow focus motor can be determined when the size of the shooting target in the shooting image of the shooting equipment is the target size under the real-time measured distance. Then the position of the follow focus motor is rotated to the determined rotation position. As such, the follow focus motor drives the lens to zoom so that the size of the shooting target in the shooting image of the shooting equipment is the target size.

Optionally, this shooting method not only controls the follow focus motor to drive the lens zoom, but also controls the shooting equipment to shoot images to obtain an image with the shooting target as the shooting size. Optionally, the method not only controls the follow focus motor to drive the lens zoom, but also controls the shooting equipment to record video to obtain a video whose size of the shooting target remains the target size.

The shooting control method of this embodiment can obtain the measured distance between the shooting target and the shooting equipment and the measured rotation position of the follow focus motor collected by the distance sensor by detecting the user's zoom confirmation operations on the first interactive device when the shooting target is at different distances from the shooting equipment. Then, the real-time measured distance between the shooting target and the shooting equipment collected by the distance sensor can be obtained. According to the real-time measured distance and the measured distances collected by the distance sensor and the measured rotation positions of the follow focus motor when the shooting target is at different distances from the shooting equipment, the follow focus motor can be controlled to drive the lens zoom so that the size of the shooting target in the shooting image of the shooting equipment is the target size. Thus, according to the real-time distance between the shooting equipment and the shooting target, sliding zoom shooting can be realized, which can simplify the user's operation and/or improve the user's experience.

In some embodiments, the handheld portion of the handheld gimbal can further include a second interactive device, and the user can perform operations on the second interactive device, such as zoom adjustment operations. Correspondingly, when the shooting equipment is at a first distance from the shooting target, the user can perform a zoom adjustment operation on the second interactive device, which is herein referred to as a first zoom adjustment operation. The first zoom adjustment operation can be used to adjust the size of the shooting target in the shooting image to the target size. Correspondingly, the handheld gimbal can detect the user's first zoom adjustment operation on the second interactive device, and control the follow focus motor to drive the lens to zoom according to the first zoom adjustment operation, so as to adjust the size of the shooting target to the target size in the shooting image of the shooting equipment. Then, when the size of the shooting target in the shooting image of the shooting equipment is the target size, the user can perform the above-mentioned first zoom confirmation on the first interactive device.

Optionally, when the shooting equipment is at a second distance from the shooting target, the user can perform a zoom adjustment operation on the second interactive device, which is herein referred to as a second zoom adjustment operation. The second zoom adjustment operation can be used to adjust the size of the shooting target in the shooting image to the target size. Correspondingly, the handheld gimbal can detect the second zoom adjustment operation of the second interactive device by the user, and control the follow focus motor to drive the lens to zoom according to the second zoom adjustment operation, so as to adjust the size of the shooting target to the target size in the shooting image of the shooting equipment. Then, when the size of the shooting target in the shooting image of the shooting equipment is the target size, the user can perform the second zoom confirmation operation on the first interactive device.

Therefore, in these embodiments, the user can perform zoom adjustment operations on the second interaction device, so that when the shooting equipment is at different distances from the shooting target, the size of the shooting target in the shooting image of the shooting equipment can be adjusted to the target size.

In a possible implementation manner, the aforementioned second interaction device includes a zoom wheel, such as the zoom wheel 103 in FIG. 2. Correspondingly, when the user needs to adjust the size of the shooting target to the target size in the shooting image of the shooting equipment, the user can perform a rotation operation on the zoom wheel. The rotation of the zoom wheel will drive the follow focus motor to rotate, and the follow focus motor rotation drives the zoom ring to rotate, and the rotation of the zoom ring drives the lens to zoom.

When the shooting equipment is at a first distance from the shooting target, the user can perform a rotating operation on the zoom wheel, which is herein referred to as the first rotation operation. The first rotation operation can control the follow focus motor to drive the lens to zoom to adjust the size of the shooting target to the target size in the shooting image of the shooting equipment.

Optionally, when the shooting equipment is at a second distance from the shooting target, the user can perform a rotating operation on the zoom wheel, which is herein referred to as the second rotation operation. The second rotation operation can control the follow focus motor to drive the lens to zoom to adjust the size of the shooting target to the target size in the shooting image of the shooting equipment.

Therefore, in these embodiments, the user can perform rotating operations on the zoom wheel, so that when the shooting equipment is at different distances from the shooting target, the size of the shooting target in the shooting image of the shooting equipment can be adjusted to the target size.

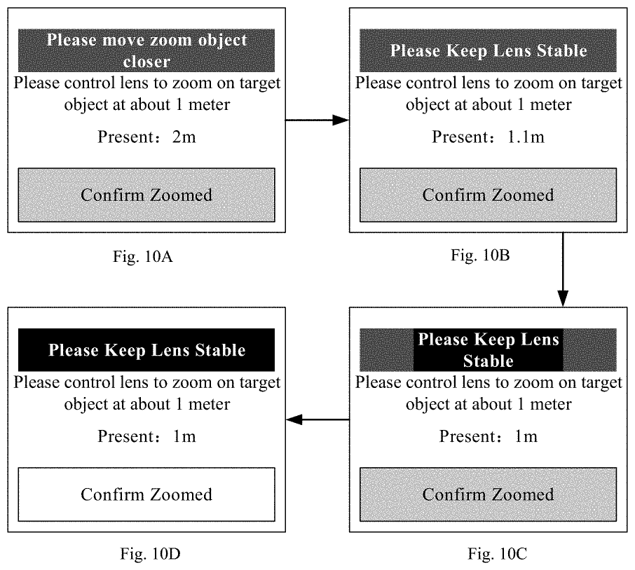

In one embodiment, the first interaction device is a touch display screen. The handheld gimbal in this embodiment can also control the touch display screen to display first distance prompt information. The first distance prompt information can be used to instruct the user to control the zoom of the shooting equipment so that the size of the shooting target in the shooting frame of the shooting equipment is the target size when the shooting equipment is about a first reference distance away from the shooting target. For example, as shown in FIG. 10A, the first reference distance is 1 meter, and the first distance prompt information can be used to instruct the user to control the lens to zoom on the target object at about 1 meter away. Among them, the distance sensor can collect the measured distance between the shooting equipment and the shooting target. Optionally, the handheld gimbal can also control the touch display screen to display the measured distance collected by the distance sensor, such as 2 meters as shown in FIG. 10A. The handheld gimbal can determine the deviation between the first reference distance and the measured distance collected by the distance sensor, and determine whether the deviation is greater than a preset deviation threshold. If the deviation between the first reference distance and the measured distance collected by the distance sensor is greater than the preset deviation threshold, the touch display screen can be controlled to display first distance adjustment information prompting the user to adjust the distance between the shooting equipment and the shooting target according to the deviation. For example, as shown in FIG. 10A, the first distance adjustment information may prompt the user to move the zoom object (shooting target) closer, and the user may move the shooting equipment closer to the shooting target according to the first distance adjustment information. If the deviation between the first reference distance and the measured distance collected by the distance sensor is less than or equal to the preset deviation threshold, it can mean that the shooting equipment is about a first reference distance from the shooting target. At this time, the shooting equipment is at the first distance from the shooting target.

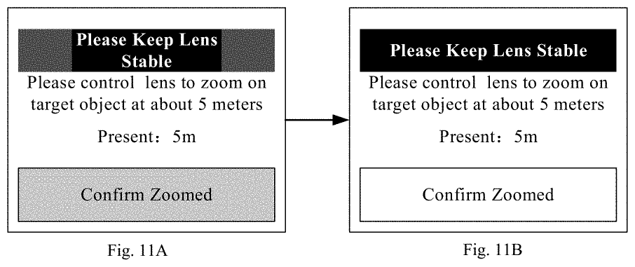

In one embodiment, the first interaction device is a touch display screen. The handheld gimbal in this embodiment can also control the touch display screen to display second distance prompt information. The second distance prompt information can be used to instruct the user to control the zoom of the shooting equipment so that when the shooting equipment is about a second reference distance away from the shooting target, the size of the shooting target in the shooting image of the shooting equipment is the target size. For example, the second reference distance is 5 meters. As shown in FIG. 11A and FIG. 11B, the second distance prompt information can be used to instruct the user to control the lens to zoom on the target object at about 5 meters. Among them, the distance sensor can collect the measured distance between the shooting equipment and the shooting target. Optionally, the handheld gimbal can also control the touch display screen to display the measured distance collected by the distance sensor. The handheld gimbal can determine the deviation between the second reference distance and the measured distance collected by the distance sensor, and determine whether the deviation is greater than a preset deviation threshold. If the deviation between the second reference distance and the measured distance collected by the distance sensor is greater than the preset deviation threshold, the touch screen can be controlled to display the second distance adjustment information prompting the user to adjust the distance between the shooting equipment and the shooting target according to the deviation. If the deviation between the second reference distance and the measured distance collected by the distance sensor is less than or equal to the preset deviation threshold, it can mean that the shooting equipment is at about a second reference distance from the shooting target. At this time, the shooting equipment is at the second distance from the shooting target.

Therefore, in those embodiments, the touch display screen can be used to display distance prompt information for instructing the user to control zooming of the lens of the shooting equipment, so that the size of the shooting target in the shooting screen is the target size when the shooting equipment is at different reference distances from the target object. The distance sensor detects the measured distance between the shooting equipment and the shooting target. According to the measured distances and the reference distances, the touch display screen displays the distance adjustment information prompting the user to adjust the distance between the shooting equipment and the shooting target, so that the user can adjust the distance between the shooting equipment and the shooting target according to the distance adjustment information. This can ensure that the distance between the shooting equipment and the shooting target is close to the above-mentioned reference distance, so that the user can perform the zoom confirmation operation when the distance is close to the reference distance.

In one embodiment, the first interaction device is a touch display screen. A possible implementation of the above S901 is: controlling the touch display screen to display the first zoom confirmation icon, and then detecting that the user confirms the operation of the first zoom confirmation on the first zoom confirmation icon when the size of the shooting target in the shooting image of the shooting equipment is the target size.

As shown in FIG. 10D, the first zoom confirmation icon is the “confirm zoomed” icon displayed in FIG. 10D. If the user observes the shooting image of the shooting equipment and determines that the size of the shooting target in the shooting image of the shooting equipment is the target size, the user can perform the first zoom confirmation operation on the first zoom confirmation icon. That is, the user can perform a click operation on the “confirm zoomed” icon shown in FIG. 10D. Accordingly, the handheld gimbal can detect the user's click operation on the “confirm zoomed” icon displayed on the touch display screen.

A possible implementation of the above S903 is: controlling the touch display screen to display the second zoom confirmation icon, and then detecting that the user confirms the second zoom operation on the second zoom confirmation icon when the size of the shooting target in the shooting image of the shooting equipment is the target size.

As shown in FIG. 10D, the second zoom confirmation icon is the “confirm zoomed” icon displayed in FIG. 10D. If the user observes the shooting image of the shooting equipment and determines that the size of the shooting target in the shooting image of the shooting equipment is the target size, the user can perform the second zoom confirmation operation on the second zoom confirmation icon. That is, the user can perform a click operation on the “confirm zoomed” icon shown in FIG. 10D. Correspondingly, the handheld gimbal can detect the user's click operation on the “confirm zoomed” icon displayed on the touch screen.

Optionally, when the distance between the shooting equipment and the shooting target is the first distance, it also can be determined whether the time period during which the shooting equipment remains stable is less than a preset time period. If the time period during which the shooting equipment remains stable is greater than or equal to the preset time period, the first zoom confirmation icon can be adjusted from the non-responsive state to the responsive state. If the time period that the shooting equipment remains stable is less than the preset time period, the touch screen can be controlled to display a prompt message for instructing to keep the shooting equipment stable, and the first zoom confirmation icon can be set to a non-responsive state.

As shown in FIG. 10B, if the deviation between the first reference distance and the measured distance between the shooting equipment and the shooting target changes from greater than the preset distance deviation threshold to less than or equal to the preset distance deviation, it can mean that the distance between the shooting equipment and the shooting target is close to the first reference distance. At this time, the distance between the shooting equipment and the shooting target is the first distance. At the same time, the touch display screen can be controlled to display a prompt message for instructing to keep the shooting equipment stable, and the first zoom confirmation icon is displayed as a non-responsive state. As shown in FIG. 10B, the “confirm zoomed” icon is a grayscale icon. The user can keep the shooting equipment stable according to the prompt information. When the handheld gimbal detects that the shooting equipment is stable, it can start to count the length of time the shooting equipment remains stable, and judge whether the time period the shooting equipment remains stable is less than the preset time period. If the shooting equipment remains stable for less than the preset time period, the touch display screen can be controlled to continue to display the first zoom confirmation icon as non-responsive. Optionally, it also can be possible to control the touch display screen to display the length of time that the shooting equipment remains stable. For example, it can display a progress bar for the time period the shooting equipment remains stable in the preset time period, as shown in FIG. 10C. If the shooting equipment remains stable for a time period greater than or equal to the preset time period, the first zoom confirmation icon displayed on the touch screen can be adjusted from the non-responsive state to the responsive state. As shown in FIG. 10D, the “confirm zoomed” icon is a lit icon.

Optionally, when the distance between the shooting equipment and the shooting target is the second distance, it also can be determined whether the time period during which the shooting equipment remains stable is less than a preset time period. If the time period during which the shooting equipment remains stable is greater than or equal to the preset time period, the second zoom confirmation icon can be adjusted from the non-responsive state to the responsive state, as shown in FIG. 11B. If the time period that the shooting equipment remains stable is less than the preset time period, the touch screen can be controlled to display a prompt message for instructing to keep the shooting equipment stable. The second zoom confirmation icon is set to a non-responsive state, as shown in FIG. 11A.

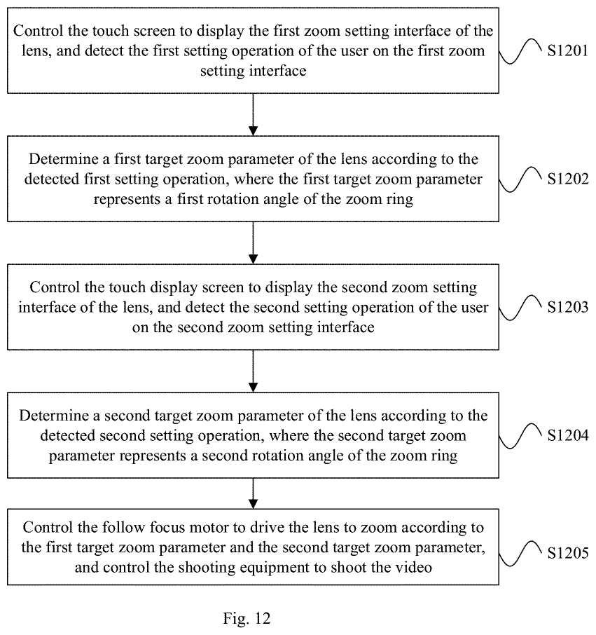

FIG. 12 is a flowchart of a shooting control method provided by an embodiment of the present disclosure. As shown in FIG. 12, the method of this embodiment can be applied to a shooting control system, which includes a handheld gimbal and a follow focus motor. The handheld gimbal includes a bearing base and a hand-held portion for carrying the shooting equipment. Please refer to the examples shown in FIGS. 1-3. Among them, the handheld portion includes a touch display screen, and the follow focus motor is meshed with the zoom ring of the lens of the shooting equipment. The execution subject of the method in this embodiment may be a handheld gimbal, and the method in this embodiment may include:

S1201. Control the touch screen to display the first zoom setting interface of the lens, and detect the first setting operation of the user on the first zoom setting interface.

S1202. Determine a first target zoom parameter of the lens according to the detected first setting operation, where the first target zoom parameter represents a first rotation angle of the zoom ring.

In this embodiment, the first zoom setting interface of the lens is displayed on the touch screen controlled by the handheld gimbal. The first zoom setting interface can be used to set the zoom parameter of one point, and then the user can perform the zoom parameter setting operation on the first zoom setting interface, which is herein referred to as the first setting operation. Correspondingly, the handheld gimbal can detect the user's first setting operation on the first zoom setting interface, and then determine the target zoom parameter of the lens of the shooting equipment according to the detected first setting operation, which is herein referred to as the first target zoom parameter. The target zoom parameter can be used to characterize the first rotation angle of the zoom ring.

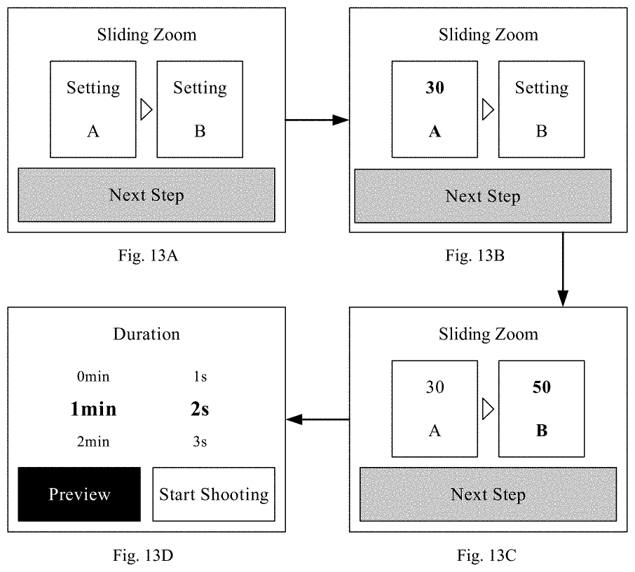

FIG. 13A shows the interface for setting the zoom parameters of two points, point A and point B respectively, which represents the change from the zoom parameter of point A to the zoom parameter of point B. When the user clicks the setting icon of point A or the “Next Step” icon shown in FIG. 13A, the handheld gimbal can control the touch display screen to display the interface shown in FIG. 13B. FIG. 13B shows the zoom setting interface of point A, which is the first zoom setting interface mentioned above. The user can perform a setting operation on the interface shown in FIG. 13B, such as sliding up and down or left and right on the focal length value icon corresponding to point A to set the focal length required by the user. The size of this focal length can represent the rotation angle of the zoom ring. For example, when the user observes that the size of the shooting target in the shooting image of the shooting equipment is the target size, the user can stop sliding. Correspondingly, the handheld gimbal can determine the first target focal length of the lens according to the user's setting operation on the interface shown in FIG. 13B, for example, 30.

S1203. Control the touch display screen to display the second zoom setting interface of the lens, and detect the second setting operation of the user on the second zoom setting interface.

S1204. Determine a second target zoom parameter of the lens according to the detected second setting operation, where the second target zoom parameter represents a second rotation angle of the zoom ring.

In this embodiment, the second zoom setting interface of the lens is displayed on the touch display screen controlled by the handheld gimbal. The second zoom setting interface can be used to set the zoom parameter of another point, and then the user can perform the zoom parameter setting operation on the second zoom setting interface, which is herein referred to as the second setting operation. Correspondingly, the handheld gimbal can detect the second setting operation of the user on the second zoom setting interface, and then can determine the target zoom parameter of the lens of the shooting equipment according to the detected second setting operation, which is herein referred to as the second target zoom parameter. This second target zoom parameter can be used to characterize the second rotation angle of the zoom ring.

As shown in FIG. 13B, after the user completes the setting operation for point A, when the user clicks the setting icon of point B or the “Next Step” icon shown in FIG. 13B, the handheld gimbal can control the touch display screen to display the interface shown in FIG. 13C. FIG. 13C shows the zoom setting interface at point B, which is the second zoom setting interface described above. The user can perform a setting operation on the interface shown in FIG. 13C, such as sliding up and down or left and right on the focal length value icon corresponding to point B to set the focal length required by the user. The size of this focal length can represent the rotation angle of the zoom ring. For example, when the user observes that the size of the shooting target in the shooting image of the shooting equipment is the target size, the user can stop sliding. Correspondingly, the handheld gimbal can determine the second target focal length of the lens according to the user's setting operation on the interface shown in FIG. 13C, for example, 50.

S1205: Control the follow focus motor to drive the lens to zoom according to the first target zoom parameter and the second target zoom parameter, and control the shooting equipment to shoot the video.

In this embodiment, since the first target zoom parameter represents the first rotation angle of the zoom ring, and the second target zoom parameter represents the second rotation angle of the zoom ring, the first rotation angle of the zoom ring can be determined according to the first target zoom parameter, and the second rotation angle of the zoom ring can be determined according to the second target zoom parameter. Then, according to the zoom ring from the first rotation angle to the second rotation angle, the rotation of the follow focus motor can be controlled to drive the lens to zoom in the process of rotating the follow focus motor to drive the zoom ring to rotate. At the same time, the shooting equipment can be controlled to shoot the video, and the size of the shooting target in the obtained video is the target size.

In those embodiments, different zoom setting interfaces can be displayed through the touch display screen of the handheld gimbal, and different target zoom parameters can be determined according to the user's setting operations on zoom setting interfaces. Then, according to each target zoom parameter, such as changing from one target zoom parameter to another target zoom parameter, the follow focus motor can be controlled to drive the lens to zoom, and the shooting equipment can be controlled to shoot video, so that the size of the shooting target on the shooting screen of the shooting equipment is the target size. Thus, according to the zoom parameters set by the user, the sliding zoom shooting function can be realized, the user's operation can be simplified, and/or the user's experience can be improved.

Based on the embodiment shown in FIG. 12, the method of this embodiment may further include: detecting a video duration setting operation of the user on the touch display screen, and determining the target video duration according to the detected video duration setting operation. Correspondingly, a possible implementation of S1205 is: controlling the follow focus motor to drive the lens to zoom according to the first target zoom parameter, the second target zoom parameter, and the target video duration, and controlling the shooting equipment to shoot the video. In this embodiment, the duration from the first target zoom parameter to the second target zoom parameter is the aforementioned target video duration, and the obtained video can be a video whose duration is the target video duration during which the first target zoom parameter is changed to the second target zoom parameter.

In this embodiment, the handheld gimbal can control the touch display screen to display the video duration setting interface. For example, as shown in FIG. 13C, when the user clicks the “Next Step” icon on the interface shown in FIG. 13C, the handheld gimbal can control the touch display screen to display the video duration setting interface, as shown in FIG. 13D. FIG. 13D shows the video duration setting interface. The user can perform setting operations on the interface shown in FIG. 13D, for example, sliding up and down on the minute value icon and the second value icon of the interface to set the duration. For example, when the user stops sliding, correspondingly, the handheld gimbal can determine the video duration according to the user's setting operation on the interface shown in FIG. 13D, for example, 1 minute and 2 seconds. When the user clicks the “Start Shooting” icon in the interface shown in FIG. 13D, the handheld gimbal can control the follow focus motor according to the focal length 30 and the focal length 50 to drive the lens to zoom, and control the shooting equipment to take 1 minute 2 seconds of video.

Therefore, through the above method, it can be possible to achieve sliding zoom shooting within the video duration set by the user.

Optionally, the shooting target is selected by the user.

Optionally, the handheld gimbal is in communication connection with the shooting equipment. For example, the handheld gimbal is directly connected to the shooting equipment through communication, or the handheld gimbal is connected to the shooting equipment through other devices (such as image transmission equipment). The shooting target is determined by detecting the user's selection operation on the touch screen displaying the shooting image of the shooting equipment.

In some of the above embodiments, the distance sensor is detachably arranged on the shooting equipment, or the distance sensor is detachably arranged on the bearing base of the handheld gimbal.

In some of the above embodiments, the follow focus motor is detachably carried on the bearing base.

In some other embodiments, the present disclosure provides a solution for realizing rotation shooting. This rotation shooting can capture the visual effect of screen rotation. This kind of rotation shooting can be called a space-time tunnel shooting solution. Specifically, the touch display screen of the handheld gimbal is controlled to display a first setting interface for rotation shooting. The first setting interface can be used to set the shooting interval for rotation shooting, detect the user's shooting interval setting operation on the touch screen, and determine the target shooting interval according to the detected shooting interval setting operation.

Optionally, the touch display screen of the handheld gimbal can be controlled to display the second setting interface of the time-space tunnel. The second setting interface can be used to set the video duration of the rotation shooting, detect the video duration setting operation on the touch display screen by the user, and determine the target video duration according to the detected video duration setting operation.

Optionally, the touch display screen of the handheld gimbal can display the third setting interface of the time-space tunnel. The third setting interface can be used to set the starting position of the rotation shooting, detect the starting position setting operation on the touch display screen by the user, and determine the target starting position according to the detected starting position setting operation.

Optionally, the touch screen of the handheld gimbal can be controlled to display the fourth setting interface for rotation shooting. The fourth setting interface can be used to set the rotation angle of the rotation shooting, detect the rotation angle setting operation on the touch display screen by the user, and determine the target rotation angle according to the detected rotation angle setting operation.

It should be noted that some embodiments of the present disclosure do not limit the sequence of determining the target shooting interval, target video duration, target starting position, and target rotation angle.

Then, the pitch axis motor of the handheld gimbal can be controlled to drive the bearing base so that the optical axis of the shooting equipment carried by the bearing base is parallel to the rotation axis of the yaw axis motor (the yaw axis of the handheld gimbal). Then, the rotation of the yaw axis motor can be controlled according to the target starting position, so that the shooting equipment rotates to the target starting position. After the shooting equipment is rotated to the target starting position, the yaw axis motor can be controlled to rotate according to the target rotation angle, so that the shooting equipment rotates the target rotation angle. In the process of controlling the rotation of the yaw axis motor according to the target rotation angle, the shooting equipment can be controlled to shoot images every interval of the target shooting interval to obtain a video of the target video duration. Wherein, in the process of controlling the rotation of the yaw axis motor according to the target rotation angle, the optical axis of the shooting equipment and the rotation axis of the yaw axis motor (the yaw axis of the handheld gimbal) can remain parallel.

Therefore, in one embodiment of the present disclosure, the setting interface can be displayed on the touch display screen of the handheld gimbal to determine the above parameters. Then, according to the above parameters, the yaw axis motor can be controlled to rotate and the shooting equipment can be controlled to shoot video, which can realize automatic rotation shooting, simplify the user's operation, and/or improve the user's experience.

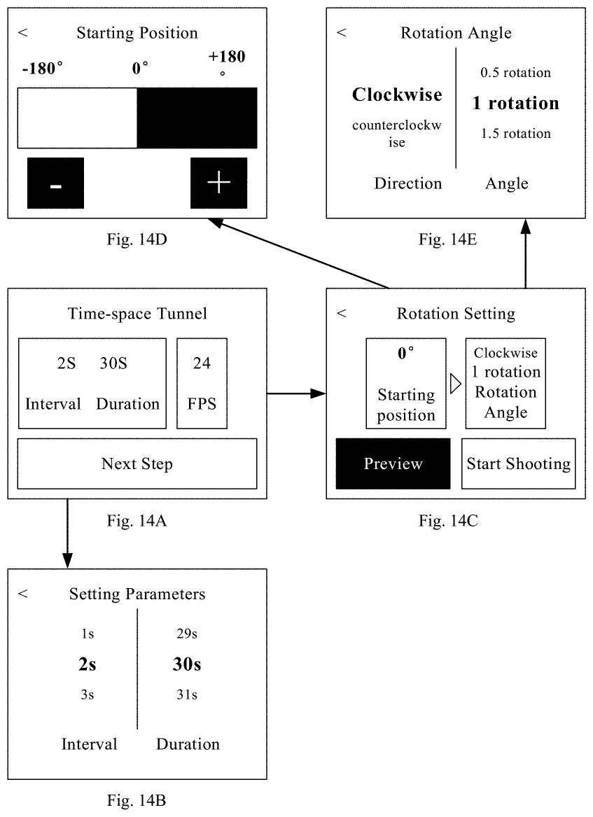

Hereinafter, the above solution is illustrated by taking the example shown in FIGS. 14A-14D. The first setting interface and the second setting interface are, for example, the same interface, and the third setting interface and the fourth setting interface are, for example, the same interface. When the user performs the operation of selecting rotation shooting, the touch display screen can be controlled to display an interface as shown in FIG. 14A, which is used to represent the setting of the shooting interval and video duration of the rotation shooting. When the user clicks on the area representing the shooting interval and video duration in the interface shown in FIG. 14A, the touch display screen can be controlled to display the interface shown in FIG. 14B. The user can perform setting operations on the interface shown in FIG. 14B, such as sliding up and down the numeric icon of the shooting interval to set the shooting interval required by the user (for example, 2 s), and sliding up and down the numeric icon of the video duration to set the video duration required by the user (for example, 30 s). When the user clicks the return icon in the interface shown in FIG. 14B, the touch display screen can be controlled to display as FIG. 14A. Optionally, the interface shown in FIG. 14A can also be used to display the frame per second (FPS) of the screen. When the user clicks on the numerical icon representing FPS, the number of adjacent frames can be switched in turn, for example, among 24, 25, 30, and 60.

When the user clicks on the “Next Step” icon in the interface shown in FIG. 14A, the touch screen can be controlled to display the interface shown in FIG. 14C, which can be used to set the starting position and rotation angle of rotation shooting. When the user clicks on the icon representing the starting position in the interface shown in FIG. 14C, the touch screen can be controlled to display the interface shown in FIG. 14D. The user can perform setting operation on the interface shown in FIG. 14D, such as clicking on the decrease icon or increase icon representing the value of the starting position to set the starting position required by the user (for example, 0°). When the user clicks the return icon in the interface shown in FIG. 14D, the touch screen can be controlled to display as FIG. 14C.

When the user clicks on the icon representing the rotation angle in the interface shown in FIG. 14C, the touch display screen can be controlled to display the interface shown in FIG. 14E. The user can set the interface shown in FIG. 14E. In FIG. 14E, the rotation angle can be determined by the rotation direction and the number of rotations. For example, the user can slide the icon of the rotation direction up and down to set the rotation direction required by the user, and slide up and down the numerical icon of the number of rotations to set the number of rotations required by the user (for example, 1 rotation). When the user clicks the return icon in the interface shown in FIG. 14E, the touch display screen can be controlled to display as FIG. 14C.

When the user clicks the “Start Shooting” icon in the interface shown in FIG. 14C, referring to FIG. 2, the handheld gimbal 100 can control the pitch axis motor 1021 to rotate, so that the optical axis of the shooting equipment carried by the bearing base 1024 is parallel to the rotation axis of the yaw axis motor 1023. Where the starting position is 0°, it can mean that the starting position is the current position of the yaw axis motor 1023. Then, the optical axis of the shooting equipment can be kept parallel to the rotation axis of the yaw axis motor 1023, control the rotation of the yaw axis motor 1023 to drive the shooting equipment to rotate in a clockwise direction, and in the process of rotating, control the shooting equipment to take a picture every 2 s to obtain a 30 s-long video with a rotation shooting effect.

It should be noted that any of the foregoing embodiments can be implemented separately, or can be implemented in any combination of at least two of the foregoing embodiments, which is not limited.

One embodiment of the present disclosure also provides a computer storage medium. The computer storage medium, which can be non-transitory computer-readable storage, can store program instructions. The program in execution may include some or all of the steps of the control method of the movable platform in any of the above embodiments.

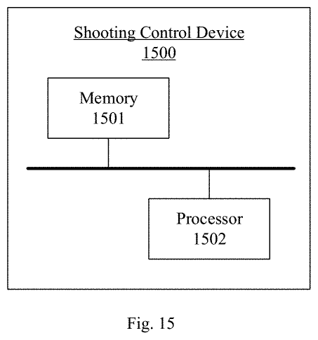

FIG. 15 is a schematic structural diagram of a shooting control device 1500 provided by an embodiment of the present disclosure. The shooting control device 1500 can be used in a shooting control system, such as shooting control system 10 discussed above. Wherein, the shooting control system can include a handheld gimbal and a follow focus motor such as described herein. The handheld gimbal can includes a bearing base for carrying a shooting equipment and a handheld portion such as described herein. The handheld portion can include a first interaction device. As shown in FIG. 15, the shooting control device 1500 of this embodiment can include: a memory 1501 and a processor 1502. The memory 1501 and the processor 1502 can be connected by a bus, such as an I2C (Inter-integrated Circuit) bus.

Wherein, the memory 1501 may be a Flash chip, a read-only memory (ROM) disk, an optical disk, a U disk, or a mobile hard disk.

The processor 1502 may be a central processing unit (CPU), other general-purpose processors, digital signal processors (DSP), disclosure specific integrated circuits (ASICs), on-site Field-Programmable Gate Array (FPGA) or other programmable logic devices, discrete gates or transistor logic devices, discrete hardware components, etc. The general-purpose processor can be a microprocessor or the processor may also be any conventional processor. The processor 1502 may be implemented in circuitry. Hence, the processor 1502 may be referred to herein as processing circuitry.

The memory 1501 can be used to store instructions.

The processor 1502 can call the instructions stored in the memory 1501 to perform one or more methods or operations as described herein, such as automatic follow focusing and/or sliding zoom operation.

Optionally, the follow focus motor is meshed with the follow focus ring of the lens of the shooting equipment, and the processor 1502 can perform automatic follow focus specifically including some or all of the following operations:

Detecting that the user performs a first focus confirmation operation on the first interactive device when the shooting target is in focus in the shooting image of the shooting equipment, where the distance between the shooting target and the shooting equipment is the first distance;

In response to the first focusing confirmation operation, recording the first measured distance between the shooting equipment and the shooting target and the first measured rotation position of the follow focus motor collected by the distance sensor;

Detecting that the user performs a second focus confirmation operation on the first interactive device when the shooting target is in focus in the shooting image of the shooting equipment, where the distance between the shooting target and the shooting equipment is the second distance;

In response to the second focus confirmation operation, recording the second measured distance between the shooting equipment and the shooting target and the second measured rotation position of the follow focus motor collected by the distance sensor;

Obtaining the real-time measured distance between the shooting equipment and the shooting target collected by the distance sensor;

According to the first measured distance, the first measured rotation position, the second measured distance, the second measured rotation position and the real-time distance, the follow focus motor is controlled to drive the lens to focus so that the target is in focus in the shooting image of the shooting equipment.

In some embodiments, the handheld portion further includes a second interaction device, the processor 1502 can also be used for some or all of the following:

When the shooting equipment is at a first distance from the shooting target, the first focus adjustment operation of the user on the second interactive device is detected, and the follow focus motor is controlled according to the detected first focus adjustment operation to drive the lens to focus so as to adjust the shooting target to the in-focus state in the shooting image of the shooting equipment.

Optionally, when the shooting equipment is at a second distance away from the shooting target, the second focus adjustment operation of the user on the second interactive device is detected, and the follow focus motor is controlled according to the detected second focus adjustment operation to drive the lens to focus so as to adjust the shooting target to an in-focus state in the shooting image of the shooting equipment.

In some embodiments, the second interaction device includes a focus wheel, and when detecting the first focus adjustment operation of the user on the second interaction device, the processor 1502 can be specifically configured to perform some or all of the following:

Detect the first turning operation of the focus wheel by the user; and/or,

when detecting the second focus adjustment operation performed by the user on the second interactive device, the processor 1502 can be specifically configured to perform some or all of the following:

detect the second rotation operation of the focus wheel by the user.

In some embodiments, the first interaction device includes a touch display screen.

In some embodiments, the processor 1502 can also be used to perform some or all of the following:

Control the touch display screen to display first distance prompt information, the first distance prompt information being used to instruct the user to focus the shooting equipment to a shooting target that is about a first reference distance away from the shooting equipment.

If the deviation between the first reference distance and the measured distance collected by the distance sensor is greater than the preset deviation threshold, the touch display screen is controlled according to the deviation to display first distance adjustment information prompting the user to adjust the distance between the shooting equipment and the shooting target. Wherein, when the deviation between the first reference distance and the measured distance collected by the distance sensor is less than or equal to the preset deviation threshold, the distance between the shooting equipment and the shooting target is the first distance.

Optionally, the processor 1502 can also be used to perform some or all of the following:

Control the touch display screen to display second distance prompt information, the second distance prompt information being used to instruct the user to focus the shooting equipment to a shooting target that is about a second reference distance away from the shooting equipment.

If the deviation between the second reference distance and the measured distance collected by the distance sensor is greater than the preset deviation threshold, the touch display screen is controlled according to the deviation to display second distance adjustment information prompting the user to adjust the distance between the shooting equipment and the shooting target. Wherein, when the deviation between the second reference distance and the measured distance collected by the distance sensor is less than or equal to the preset deviation threshold, the distance between the shooting equipment and the shooting target is the second distance.

In some embodiments, when detecting that the user performs the first focusing confirmation operation on the first interactive device when the shooting target is in the in-focus state in the shooting image of the shooting equipment, the processor 1502 can be specifically configured to perform some or all of the following:

Control the touch display screen to display the first focus confirmation icon;

Detect that the user performs the first focus confirmation operation on the first focus confirmation icon when the shooting target is in focus in the shooting image of the shooting equipment;

Optionally, when detecting that the user performs the second focus confirmation operation on the first interactive device when the shooting target is in the in-focus state in the shooting image of the shooting equipment, the processor 1502 can be specifically configured to perform some or all of the following:

Control the touch display screen to display the second focus confirmation icon;

detect that the user performs a second focus confirmation operation on the second focus confirmation icon when the shooting target is in the in-focus state in the shooting image of the shooting equipment.

In some embodiments, the processor 1502 can also be used to perform some or all of the following:

when the distance between the shooting equipment and the shooting target is the first distance, if the time period during which the shooting equipment remains stable is greater than or equal to the preset time period, adjust the first focus confirmation icon from the non-responsive state to the responsive state; and/or

when the distance between the shooting equipment and the shooting target is the second distance, if the time period during which the shooting equipment remains stable is greater than or equal to the preset time period, adjust the second focus confirmation icon from the non-responsive state to the responsive state.

In some embodiments, the first interaction device is a touch display screen, and the processor 1502 can be further configured to perform some or all of the following:

control the touch display screen to display the first focus setting interface of the lens, and detect the first setting operation on the first focus setting interface by the user;

determine the first target focus parameter of the lens according to the detected first setting operation, where the first target focus parameter represents the first rotation angle of the follow focus ring;

control the touch screen to display the second focus setting interface of the lens, and detect the second setting operation on the second focus setting interface by the user;

determine the second target focus parameter of the lens according to the detected second setting operation, where the second target focus parameter represents the second rotation angle of the follow focus ring; and

according to the first target focus parameter and the second target focus parameter, the follow focus motor is controlled to drive the lens to focus, and the shooting equipment is controlled to shoot video.

In some embodiments, the processor 1502 can also used to perform some or all of the following:

detect the video duration setting operation of the user on the touch screen, and determine the target video duration according to the detected video duration setting operation;

Optionally, when the processor 1502 controls the follow focus motor to drive the lens to focus according to the first target focus parameter and the second target focus parameter, the processor 1502 can be specifically used for performing some or all of the following:

according to the first target focus parameter, the second target focus parameter and the target video duration, the follow focus motor is controlled to drive the lens to focus.

Wherein, the follow focus motor is meshed with the zoom ring of the lens of the shooting equipment, and the processor 1502 performing sliding zoom can specifically include some or all of the following operations:

Detecting that the user confirms the first zoom operation of the first interactive device when the size of the shooting target in the shooting image of the shooting equipment is the target size, wherein the distance between the shooting target and the shooting equipment is the first distance;

In response to the first zoom confirmation operation, recording the first measured distance between the shooting equipment and the shooting target and the first measured rotation position of the follow focus motor collected by the distance sensor;

Detecting that the user confirms the second zoom operation of the first interactive device when the size of the shooting target in the shooting frame of the shooting equipment is the target size, wherein the distance between the shooting target and the shooting equipment is the second distance;

In response to the second zoom confirmation operation, recording the second measured distance between the shooting equipment and the shooting target and the second measured rotation position of the follow focus motor collected by the distance sensor;

Obtaining the real-time measured distance between the shooting equipment and the shooting target collected by the distance sensor;

According to the first measured distance, the first measured rotation position, the second measured distance, the second measured rotation position and the real-time distance, the follow focus motor is controlled to drive the lens to zoom so that the size of the shooting target in the shooting image of the shooting equipment is the target size.

In some embodiments, the handheld portion further includes a second interaction device, the processor 1502 can also be used for performing some or all of the following:

When the shooting equipment is at a first distance from the shooting target, the user's first zoom adjustment operation on the second interactive device is detected, and the follow focus motor is controlled according to the detected first zoom adjustment operation to drive the lens to zoom to adjust the size of the shooting target to the target size in the shooting image of the shooting equipment; and/or,

When the shooting equipment is at a second distance from the shooting target, the second zoom adjustment operation on the second interactive device by the user is detected, and the follow focus motor is controlled according to the detected second zoom adjustment operation to drive the lens to zoom to adjust the size of the shooting target to the target size in the shooting image of the shooting equipment.

In some embodiments, the second interaction device includes a zoom wheel, wherein,

When the processor 1502 detects the user's first zoom adjustment operation on the second interaction device, the processor 1502 can be specifically configured to perform some or all of the following:

Detect the first turning operation of the zoom wheel by the user; and/or,

When the processor 1502 detects the second zoom adjustment operation on the second interaction device by the user, the processor 1502 can be specifically configured to perform some or all of the following:

Detect the second rotation operation of the zoom wheel by the user.

In some embodiments, the first interaction device includes a touch display screen.

In some embodiments, the processor 1502 can also be used to perform some or all of the following:

control the touch display screen to display the first distance prompt information. The first distance prompt information can be used to instruct the user to control the zoom of the shooting equipment so that when the shooting equipment is about the first reference distance from the shooting target, the size of the shooting target in the shooting screen of the shooting equipment is the target size.

If the deviation between the first reference distance and the measured distance collected by the distance sensor is greater than the preset deviation threshold, the touch display screen can be controlled according to the deviation to display first distance adjustment information prompting the user to adjust the distance between the shooting equipment and the shooting target. Wherein, when the deviation between the first reference distance and the measured distance collected by the distance sensor is less than or equal to the preset deviation threshold, the distance between the shooting equipment and the shooting target is the first distance.

In some embodiments, the processor 1502 can also be used to perform some or all of the following:

control the touch display screen to display the second distance prompt information. The second distance prompt information is used to instruct the user to control the zoom of the shooting equipment so that when the shooting equipment and the shooting target are about a second reference distance away, the size of the shooting target in the shooting image of the shooting equipment is the target size.

If the deviation between the second reference distance and the measured distance collected by the distance sensor is greater than the preset deviation threshold, the touch screen can be controlled according to the deviation to display second distance adjustment information prompting the user to adjust the distance between the shooting equipment and the shooting target. Wherein, when the deviation between the second reference distance and the measured distance collected by the distance sensor is less than or equal to the preset deviation threshold, the distance between the shooting equipment and the shooting target is the second distance.

In some embodiments, when detecting that the size of the shooting target in the shooting image of the shooting equipment by the user is the target size, when confirming the first zoom operation of the first interactive device, the processor 1502 can be specifically configured to perform some or all of the following:

control the touch screen to display the first zoom confirmation icon; and

detect that the user performs the first zoom confirmation operation on the first zoom confirmation icon when the size of the shooting target in the shooting image of the shooting equipment is the target size.

when detecting that the size of the shooting target in the shooting frame of the shooting equipment by the user is the target size, when confirming the second zoom operation of the first interactive device, the processor 1502 can be specifically configured to perform some or all of the following:

control the touch display screen to display the second zoom confirmation icon; and

detect that, when the size of the shooting target in the shooting frame of the shooting equipment is the target size, the user performs the second zoom confirmation operation on the second zoom confirmation icon.

In some embodiments, the processor 1502 can also be used to perform some or all of the following:

when the distance between the shooting equipment and the shooting target is the first distance, if the time period the shooting equipment remains stable is greater than or equal to the preset time period, the first zoom confirmation icon can be adjusted from the non-responsive state to the responsive state; and

when the distance between the shooting equipment and the shooting target is the second distance, if the time period during which the shooting equipment remains stable is greater than or equal to the preset time period, the second zoom confirmation icon can be adjusted from the non-responsive state to the responsive state.

In some embodiments, the first interaction device is a touch display screen, and the processor 1502 can be further configured to perform some or all of the following:

control the touch screen to display the first zoom setting interface of the lens, and detect the first setting operation on the first zoom setting interface by the user;

determine the first target zoom parameter of the lens according to the detected first setting operation, where the first target zoom parameter represents the first rotation angle of the zoom ring;

control the touch screen to display the second zoom setting interface of the lens, and detect the second setting operation on the second zoom setting interface by the user;

determine a second target zoom parameter of the lens according to the detected second setting operation, where the second target zoom parameter represents a second rotation angle of the zoom ring; and

according to the first target zoom parameter and the second target zoom parameter, control the follow focus motor to drive the lens to zoom, and control the shooting equipment to shoot the video.

In some embodiments, the processor 1502 can also be used to perform some or all of the following:

detect the video duration setting operation on the touch screen by the user, and determine the target video duration according to the detected video duration setting operation;

Optionally, when the processor 1502 controls the follow focus motor to drive the lens to zoom according to the first target zoom parameter and the second target zoom parameter, the processor 1502 can be specifically used for performing some or all of the following:

according to the first target zoom parameter, the second target zoom parameter and the target video duration, controlling the follow focus motor to drive the lens to zoom.

In some embodiments, the target size is set by the user.

In some embodiments, the shooting target is selected by the user.

In some embodiments, the handheld gimbal is communicatively connected with the shooting equipment, and the shooting target is determined by detecting the user's selection operation on the touch screen that displays the shooting image of the shooting equipment.

In some embodiments, the distance sensor is detachably arranged on the shooting equipment, or the distance sensor is detachably arranged on the bearing base.

In some embodiments, the follow focus motor is detachably carried on the bearing base.

The shooting control device of this embodiment can be used to implement the technical solutions of the foregoing method embodiments of the present disclosure, and the implementation principles and technical effects are similar, and will not be repeated here.

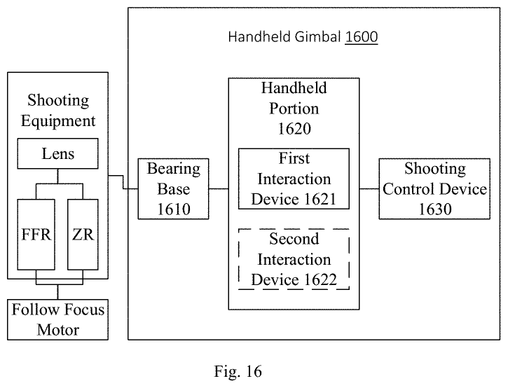

FIG. 16 is a schematic structural diagram of a handheld gimbal 1600 provided by an embodiment of the disclosure. The handheld gimbal of this embodiment can be used in a shooting control system, where the shooting control system can include the handheld gimbal 1600 and a follow focus motor. The handheld gimbal 1600 of this embodiment can include: a bearing base 1610 for carrying shooting equipment and a handheld portion 1620. The handheld portion 1620 can include a first interaction device 1621. The follow focus motor can be meshed with the follow focus ring (FFR) or zoom ring (ZR) of the lens of the shooting equipment. In addition, the handheld gimbal 1600 also can include a shooting control device 1630.

Optionally, the handheld portion 1620 can further include a second interaction device 1622.

Wherein, the shooting control device 1630 may adopt the structure of the device embodiment shown in FIG. 15, and correspondingly, may execute one or more technical solutions provided by any of the foregoing method embodiments.

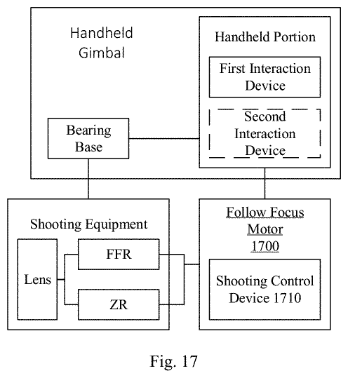

FIG. 17 is a schematic structural diagram of a follow focus motor 1700 provided by an embodiment of the disclosure. The follow focus motor 1700 of this embodiment can be used in a shooting control system, where the shooting control system can include a handheld gimbal and the follow focus motor 1700. The handheld gimbal can include: a bearing base for carrying the shooting equipment and a handheld portion, and the handheld portion can include a first interaction device. The follow focus motor 1700 of this embodiment can be meshed with the follow focus ring or zoom ring of the lens of the shooting equipment. In addition, the follow focus motor 1700 can includes a shooting control device 1710.

Wherein, the shooting control device 1710 may adopt the structure of the device embodiment shown in FIG. 15, and correspondingly, may execute one or more technical solutions provided by any of the foregoing method embodiments, which will not be repeated here.

A person of ordinary skill in the art can understand that all or part of the steps in the above method embodiments can be implemented by a program instructing relevant hardware. The foregoing program can be stored in a computer readable storage medium. When the program is executed, it executes the steps including the above method embodiments. The foregoing storage medium includes: read-only memory (ROM), random access memory (RAM), magnetic disk or optical disk, or various media that can store program codes.

Finally, it should be noted that the above embodiments are only used to illustrate the technical solutions of the disclosure, not to limit it; although the disclosure has been described in detail with reference to the foregoing embodiments, those of ordinary skill in the art should understand: it is still possible to modify the technical solutions described in the foregoing embodiments, or equivalently replace some or all of the technical features; these modifications or replacements do not make the essence of the corresponding technical solutions deviate from the technical solutions of the embodiments of the disclosure range.

What is claimed is:

1. A shooting control method for a shooting control system, the shooting control system comprising a handheld gimbal and a follow focus motor, the handheld gimbal comprising a bearing base to carry a shooting equipment and a handheld portion, the handheld portion comprising a first interaction device, and the follow focus motor being meshed with a follow focus ring of a lens of the shooting equipment, the method comprising:
detecting, using a processor, a first focus confirmation operation of a user on the first interactive device when a shooting target is in focus in a shooting image of the shooting equipment and a distance between the shooting target and the shooting equipment is a first distance;
in response to the first focusing confirmation operation, recording, using the processor, a first measured distance between the shooting equipment and the shooting target collected by a distance sensor and a first measured rotation position of the follow focus motor;
detecting, using the processor, a second focus confirmation operation of the user on the first interactive device when the shooting target is in focus in the shooting image of the shooting equipment and the distance between the shooting target and the shooting equipment is a second distance;
in response to the second focus confirmation operation, recording, using the processor, a second measured distance between the shooting equipment and the shooting target collected by the distance sensor and a second measured rotation position of the follow focus motor;
acquiring, using the processor, a real-time measured distance between the shooting equipment and the shooting target collected by the distance sensor; and
controlling, using the processor, the follow focus motor to drive the lens to focus so that the shooting target is in focus in the shooting image of the shooting equipment according to the first measured distance, the first measured rotation position, the second measured distance, the second measured rotation position, and the real-time measured distance.

2. The shooting control method of claim 1, wherein the handheld portion further comprises a second interaction device, the method further comprising:
detecting a first focus adjustment operation of the user on the second interaction device when the shooting equipment is at the first distance from the shooting target, and controlling the follow focus motor to drive the lens to focus so as to adjust the shooting target to be in focus in the shooting image of the shooting equipment according to the detected first focus adjustment operation; and/or
detecting a second focus adjustment operation of the user on the second interaction device when the shooting equipment is at the second distance from the shooting target, and controlling the follow focus motor to drive the lens to focus so as to adjust the shooting target to be in focus in the shooting image of the shooting equipment according to the detected second focus adjustment operation.

3. The shooting control method of claim 2,
wherein the second interaction device further comprises a focus wheel, and
wherein
said detecting the first focus adjustment operation on the second interaction device of the user comprises detecting a first turning operation of the focus wheel by the user; and/or
said detecting the second focus adjustment operation of the user on the second interaction device comprises detecting a second turning operation of the focus wheel by the user.

4. The shooting control method of claim 1, wherein the first interaction device comprises a touch display screen.

5. The shooting control method of claim 4, further comprising:
controlling the touch display screen to display first distance prompt information instructing the user to focus the shooting equipment to the shooting target that is associated with a first reference distance away from the shooting equipment;
controlling the touch display screen to display first distance adjustment information instructing the user to adjust the distance between the shooting equipment and the shooting target according to a first deviation between the first reference distance and the first measured distance collected by the distance sensor when the first deviation is greater than a preset deviation threshold, wherein when the first deviation between the first reference distance and the first measured distance collected by the distance sensor is less than or equal to the preset deviation threshold, the distance between the shooting equipment and the shooting target is the first distance;
controlling the touch display screen to display second distance prompt information instructing the user to focus the shooting equipment to the shooting target that is associated with a second reference distance away from the shooting equipment; and
controlling the touch display screen to display second distance adjustment information instructing the user to adjust the distance between the shooting equipment and the shooting target according to a second deviation between the second reference distance and the second measured distance collected by the distance sensor when the second deviation is greater than the preset deviation threshold, wherein when the second deviation between the second reference distance and the second measured distance collected by the distance sensor is less than or equal to the preset deviation threshold, the distance between the shooting equipment and the shooting target is the second distance.

6. The shooting control method of claim 4,
wherein said detecting the first focus confirmation operation of the user on the first interactive device when the shooting target is in focus in the shooting image of the shooting equipment comprises:
controlling the touch display screen to display a first focus confirmation icon, and
detecting the first focus confirmation operation of the user on the first focus confirmation icon when the shooting target is in focus in the shooting image of the shooting equipment; and
wherein said detecting the second focus confirmation operation of the user on the first interactive device when the shooting target is in focus in the shooting image of the shooting equipment comprises:
controlling the touch display screen to display a second focus confirmation icon, and
detecting the second focus confirmation operation of the user on the second focus confirmation icon when the shooting target is in focus in the shooting image of the shooting equipment.

7. The shooting control method of claim 6, further comprising:
adjusting the first focus confirmation icon from a first non-responsive state to a first responsive state when the distance between the shooting equipment and the shooting target is the first distance and when a first time period that the shooting equipment remains stable is greater than or equal to a preset time period; and
adjusting the second focus confirmation icon from a second non-responsive state to a second responsive state when the distance between the shooting equipment and the shooting target is the second distance and when a second time period that the shooting equipment remains stable is greater than or equal to the preset time period.

8. The shooting control method of claim 1, wherein the first interaction device comprises a touch display screen, the method further comprising:
controlling the touch display screen to display a first focus setting interface of the lens, and detecting a first setting operation of the user on the first focus setting interface;
determining a first target focus parameter of the lens according to the detected first setting operation, wherein the first target focus parameter represents a first rotation angle of the follow focus ring;
controlling the touch display screen to display a second focus setting interface of the lens, and detecting a second setting operation of the user on the second focus setting interface;
determining a second target focus parameter of the lens according to the detected second setting operation, wherein the second target focus parameter represents a second rotation angle of the follow focus ring; and
controlling the follow focus motor to drive the lens to focus according to the first target focus parameter and the second target focus parameter, and controlling the shooting equipment to shoot a video.

9. The shooting control method of claim 8, further comprising:
detecting a video duration setting operation of the user on the touch display screen, and determining a target video duration according to the detected video duration setting operation; and
said controlling the follow focus motor to drive the lens to focus according to the first target focus parameter and the second target focus parameter comprises:
controlling the follow focus motor to drive the lens to focus according to the first target focus parameter, the second target focus parameter, and the target video duration.

10. The shooting control method of claim 1, wherein the shooting target is selected by the user according to a selection operation.

11. The shooting control method of claim 10, wherein the handheld gimbal is in communication connection with the shooting equipment, and the shooting target is selected by detecting the selection operation of the user on a touch display screen that displays the shooting image of the shooting equipment.

12. The shooting control method of claim 1, wherein the distance sensor is detachably arranged on the shooting equipment, or the distance sensor is detachably arranged on the bearing base.

13. The shooting control method of claim 1, wherein the follow focus motor is detachably carried on the bearing base.

14. A shooting control device for a shooting control system, the shooting control system comprising a handheld gimbal and a follow focus motor, the handheld gimbal comprising a bearing base to carry a shooting equipment and a handheld portion, the handheld portion comprising a first interaction device, and the follow focus motor meshed with a follow focus ring of a lens of the shooting equipment, the shooting control device comprising:
a memory and processing circuitry;
wherein the memory is configured to store instructions; and
the processing circuitry is configured to call the instructions stored in the memory to:
detect a first focus confirmation operation of a user on the first interactive device when a shooting target is in focus in a shooting image of the shooting equipment and a distance between the shooting target and the shooting equipment is a first distance;
in response to the first focusing confirmation operation, record a first measured distance between the shooting equipment and the shooting target collected by a distance sensor and a first measured rotation position of the follow focus motor;
detect a second focus confirmation operation of the user on the first interactive device when the shooting target is in focus in the shooting image of the shooting equipment and the distance between the shooting target and the shooting equipment is a second distance;
in response to the second focus confirmation operation, record a second measured distance between the shooting equipment and the shooting target collected by the distance sensor and a second measured rotation position of the follow focus motor;
acquire a real-time measured distance between the shooting equipment and the shooting target collected by the distance sensor; and
control the follow focus motor to drive the lens to focus so that the shooting target is in focus in the shooting image of the shooting equipment according to the first measured distance, the first measured rotation position, the second measured distance, the second measured rotation position, and the real-time measured distance.

15. The shooting control device of claim 14,
wherein the handheld portion further comprises a second interaction device, and
wherein the processor is further configured to:
detect a first focus adjustment operation of the user on the second interaction device when the shooting equipment is at the first distance from the shooting target, and control the follow focus motor to drive the lens to focus so as to adjust the shooting target to be in focus in the shooting image of the shooting equipment according to the detected first focus adjustment operation; and/or
detect a second focus adjustment operation of the user on the second interaction device when the shooting equipment is at the second distance from the shooting target, and control the follow focus motor to drive the lens to focus so as to adjust the shooting target to be in focus in the shooting image of the shooting equipment according to the detected second focus adjustment operation.

16. The shooting control device of claim 15,
wherein the second interaction device comprises a focus wheel, and
wherein
the detecting the first focus adjustment operation on the second interaction device of the user comprises detecting a first turning operation of the focus wheel by the user; and/or
the detecting the second focus adjustment operation of the user on the second interaction device comprises detecting a second turning operation of the focus wheel by the user.

17. The shooting control device of claim 14,
wherein the first interaction device comprises a touch display screen, and
wherein the processing circuitry is further configured to:
control the touch display screen to display first distance prompt information instructing the user to focus the shooting equipment to the shooting target that is associated with a first reference distance away from the shooting equipment;
control the touch display screen to display first distance adjustment information instructing the user to adjust the distance between the shooting equipment and the shooting target according to a first deviation between the first reference distance and the first measured distance collected by the distance sensor when the first deviation is greater than a preset deviation threshold, wherein when the first deviation between the first reference distance and the first measured distance collected by the distance sensor is less than or equal to the preset deviation threshold, the distance between the shooting equipment and the shooting target is the first distance;
control the touch display screen to display second distance prompt information instructing the user to focus the shooting equipment to the shooting target associated with a second reference distance away from the shooting equipment;
control the touch display screen to display second distance adjustment information instructing the user to adjust the distance between the shooting equipment and the shooting target according to a second deviation between the second reference distance and the second measured distance collected by the distance sensor when the second deviation is greater than the preset deviation threshold, wherein the second deviation between the second reference distance and the measured distance collected by the distance sensor is less than or equal to the preset deviation threshold, the distance between the shooting equipment and the shooting target is the second distance.

18. The shooting control device of claim 17,
wherein the detecting the first focus confirmation operation of the user on the first interactive device when the shooting target is in focus in the shooting image of the shooting equipment comprises:
controlling the touch display screen to display a first focus confirmation icon, and
detecting the first focus confirmation operation of the user on the first focus confirmation icon when the shooting target is in focus in the shooting image of the shooting equipment; and
wherein the detecting the second focus confirmation operation of the user on the first interactive device when the shooting target is in focus in the shooting image of the shooting equipment comprises:
controlling the touch display screen to display a second focus confirmation icon, and
detecting the second focus confirmation operation of the user on the second focus confirmation icon when the shooting target is in focus in the shooting image of the shooting equipment.

19. The shooting control device of claim 18, wherein the processing circuitry is further configured to:
adjust the first focus confirmation icon from a first non-responsive state to a first responsive state when the distance between the shooting equipment and the shooting target is the first distance and when a first time period that the shooting equipment remains stable is greater than or equal to a preset time period; and
adjust the second focus confirmation icon from a second non-responsive state to a second responsive state when the distance between the shooting equipment and the shooting target is the second distance and when a second time period that the shooting equipment remains stable is greater than or equal to the preset time period.

20. The shooting control device of claim 14,
wherein the first interaction device comprises a touch display screen, and
wherein the processing circuitry is further configured to:
control the touch display screen to display a first focus setting interface of the lens, and detect a first setting operation of the user on the first focus setting interface;
determine a first target focus parameter of the lens according to the detected first setting operation, wherein the first target focus parameter represents a first rotation angle of the follow focus ring;
control the touch display screen to display a second focus setting interface of the lens, and detect a second setting operation of the user on the second focus setting interface;
determine a second target focus parameter of the lens according to the detected second setting operation, wherein the second target focus parameter represents a second rotation angle of the follow focus ring; and
control the follow focus motor to drive the lens to focus according to the first target focus parameter and the second target focus parameter, and control the shooting equipment to shoot a video.

21. The shooting control device of claim 20, wherein the processing circuitry is further configured to:
detect a video duration setting operation of the user on the touch display screen, and determine a target video duration according to the detected video duration setting operation; and
the control of the follow focus motor to drive the lens to focus according to the first target focus parameter and the second target focus parameter comprises:
controlling the follow focus motor to drive the lens to focus according to the first target focus parameter, the second target focus parameter, and the target video duration.
